(19) United States
(12) Patent Application Publication
(10) Pub. No.: US 2010/0208829 A1
(43) Pub. Date: Aug. 19, 2010

(54) BITSTREAM DECODING DEVICE AND METHOD HAVING DECODING SOLUTION

(76) Inventors: Euee-Seon Jang, Seoul (KR); Hyun-Gyu Kim, Seoul (KR); Chung-Ku Lee, Incheon (KR)

Correspondence Address: BIRCH STEWART KOLASCH & BIRCH, PO BOX 747, FALLS CHURCH, VA, 22040-0747, US

(21) Appl. No.: 12/594,551

(22) PCT Filed: Apr. 4, 2008
(86) PCT No.: PCT/KR08/01927

§ 371 Date: Oct. 2, 2009

(30) Foreign Application Priority Data
Apr. 4, 2007 (KR) 10-2007-0033483
Apr. 4, 2007 (KR) 10-2007-0033489

(51) Int. Cl. H04N 7/26

(52) U.S. Cl. 375/240.25; 375/E07.027

(57) ABSTRACT

A decoding device and method are disclosed.

With the present invention, a bit-stream, encoded by various formats according to each standard (e.g. MPEG-1, MPEG-2, MPEG-4 and MPEG-4 AVC), can be decoded by the same information recognizing method. A decoding device includes: a tool box including a plurality of functional units, each of which is realized to perform a predetermined process; and a decoder implementation unit controlling to selectively load the functional units and to decode inputted bitstream into video data by using partial decoder descriptions.

### TECHNICAL FIELD

The present invention relates to a bitstream decoding device and method, and more particularly to a bitstream decoding device and method having a decoding solution.

### BACKGROUND ART

Typically, video data is converted into bitstream data by an encoder. At this time, the bitstream is stored depending on the encoding type that satisfies the constraint condition of the encoder.

MPEG, which is the constraint condition of the bitstream, requests syntax and semantics.

The syntax, which refers to the structure, format, or length of data, shows the sequence of expressing the data. In other words, the syntax is to meet a rule for encoding/decoding and defines the sequence, length, format, and the like of each element in the bitstream.

The semantics refers to the meaning of each bit forming data. In other words, the semantics shows the meaning of each element in the bitstream.

Accordingly, various types of bitstreams can be generated depending on the encoding condition or the applied standard (or codec) of the encoder. Typically, each standard (e.g. MPEG-1, MPEG-2, MPEG-4, and MPEG-4 AVC, etc.) has different bitstream syntax.

Therefore, it can be said that the bitstream encoded according to each standard or encoding condition has different types (i.e. syntax and semantics). A decoder corresponding to a pertinent encoder may be used for the deciding of the bitstream.

As described above, the conventional bitstream decoder has a restriction that must satisfy the constraint condition of the encoder. This restriction makes it difficult to implement a united decoder corresponding to a plurality of standards.

### DISCLOSURE

### Technical Problem

Accordingly, the present invention, which is designed to solve the aforementioned problems, provides a method and device having a decoding solution for decoding a bitstream that is encoded by various types (syntax and semantics) in accordance with each standard (e.g. MPEG-1, MPEG-2, MPEG-4, MPEG-4 AVC) by using the same information recognizing method.

Further, the present invention provides a method and device for decoding a bitstream having a decoding solution that can parse a bitstream compressed by various encoding methods by using the same information analyzing method and systematically control each functional unit for decoding by using the parsed data.

Further, the present invention provides a method and device for encoding/decoding a bitstream that can universally apply a syntax analysis method to decode various types of bitstreams.

Further, the present invention provides a method and device having a decoding solution for encoding/decoding a bitstream that can apply a new set of commands to parse various types of bitstreams by a common syntax analysis method.

Further, the present invention provides a method and device having a decoding solution for decoding a bitstream that can decode bitstreams even when a syntax element is changed, added, or deleted.

Further, the present invention provides a method and device having a decoding solution for decoding a bitstream that can share elements used for the bitstream decoding of the element information (i.e. a result from syntax parsing) of analyzed syntax.

Further, the present invention provides a method and device having a decoding solution for decoding a bitstream that can use the element information of analyzed syntax for analyzing the syntax element of a following bitstream.

Further, the present invention provides a method and device having a decoding solution for decoding a bitstream that can separate functions, which are included during various decoding processes suggested by several standards (codec), corresponding to each functional unit and provide the result into a tool-box.

Further, the present invention provides a method and device having a decoding solution for decoding a bitstream that can selectively use only necessary functional units from the tool box to decode a bitstream encoded by various types.

Further, the present invention provides a method and device having a decoding solution for decoding a bitstream that can allow easy changing, inserting, or deleting functional units stored in the tool box.

Further, the present invention is to aim at international standardization of codec unification and its structures for the bitstream decoding.

Other problems that the present invention solves will become more apparent through the following description.

### Technical Solution

To solve the above problems, an aspect of the present invention features an encoding device/decoding device and/or a unified codec device that can be universally used for various standards.

According to an embodiment of the present invention, a decoding device can include: a tool box including a plurality of functional units realized to perform a predetermined process; and a decoder implementation unit controlling to load selectively the functional units and to decode inputted bitstream into video data by using partial decoder descriptions.

According to another embodiment of the present invention, an encoding device can include: an encoding unit, converting inputted video data into a bitstream according to a predetermined encoding method by successively using a plurality of functional units; and a description information generating unit, generating syntax information of the bitstream and description information according to the connection of the functional units. The bitstream and the description information are provided to a decoding device.

According to another embodiment of the present invention, a decoding device can include: a decoder implementation unit generating and outputting Control Signal/Context Information (CSCI) control information and connection control information using partial decoder descriptions stored in a description storing unit; a tool box including a plurality of functional units realized to perform a predetermined process; and a decoding solution loading selectively the functional units and decoding a bitstream into video data by using the CSCI and the connection control information.

According to another embodiment of the present invention, a decoding device can include: a decoder implementation unit generating and outputting CSCI control information and connection control information using partial decoder descriptions stored in a description storing unit; and a decoding solution decoding a bitstream into video data by selectively loading functional units using the CSCI control information and connection control information.

According to another embodiment of the present invention, a decoding method can include: (a) generating and storing a plurality of partial decoder descriptions corresponding to the inputted decoder description; (b) loading selectively a functional unit by using at least one partial decoder description; and (c) the loaded functional unit performing a predetermined process for decoding inputted bitstream.

According to another embodiment of the present invention, a decoding method can include: (a) generating and storing a plurality of partial decoder descriptions corresponding to the inputted decoder description; (b) generating CSCI control information and connection control information using the partial decoder descriptions; (c) storing a plurality of element information generated by syntax parsing of the bitstream using CSCI control information; (d) decoding the encoded video data of the bitstream using the connection control information and the element information and outputting decoded video data.

Hereinafter, preferred embodiments will be described in detail with reference to the accompanying drawings. Identical or corresponding elements will be given the same reference numerals, regardless of the figure number, and any redundant description of the identical or corresponding elements will not be repeated.

### ADVANTAGEOUS EFFECTS

As described above, the present invention can decode a bit steam encoded by various types (syntax and semantics) in accordance with each standard (e.g. MPEG-1, MPEG-2, MPEG-4, MPEG-4 AVC) by using the same information recognizing method.

The present invention can parse a bit stream compressed by various methods by using the same information analyzing method and organically control each functional unit for decoding by using the parsed data.

The present invention can commonly apply a syntax analyzing method for decoding various types of bitstreams.

The present invention can apply a set of new commands for being capable of parsing a bit stream in various forms by using a common syntax analyzing method.

The present invention can easily decode a bit stream when a syntax element is changed, added or deleted.

The present invention can share elements used for the bit stream decoding of the element information (i.e. a result from syntax parsing) of analyzed syntax.

The present invention can use the element information of analyzed syntax to analyze a following bit stream syntax element.

The present invention can be used when unifying moving picture and still image codecs processed in units of block in addition to MPEG-1, MPEG-2, MPEG-4 and MPEG-4 AVC.

The present invention can divide the functions forming various decoding methods suggested by diverse standards (codecs) per each functional unit and store the divided functions in a toolbox.

The present invention can select in a toolbox and decode a functional unit necessary for decoding a bit stream encoded in various forms.

In addition, the present invention can change, add or delete a functional unit stored in a tool box.

### DESCRIPTION OF DRAWINGS

FIG. 1 is a schematic block diagram illustrating the structure of a typical decoder.

FIG. 2 is a schematic block diagram illustrating the structure of a typical encoder.

FIG. 3 is a schematic block diagram illustrating the structure of a decoder in accordance with an embodiment of the present invention.

FIG. 4 is a schematic block diagram illustrating the structure of an extended bitstream in accordance with an embodiment of the present invention.

FIG. 5 is a schematic block diagram illustrating the structure of a decoding processing unit in accordance with a first embodiment of the present invention.

FIG. 6 is a schematic block diagram illustrating the structure of a decoding processing unit in accordance with a second embodiment of the present invention.

FIG. 7 illustrates function units for syntax (SYN) parsing in accordance with an embodiment of the present invention.

FIG. 8 illustrates function units for decoding processing in accordance with an embodiment of the present invention.

FIG. 9 is a schematic block diagram illustrating the structure of an extended bitstream in accordance with a first embodiment of the present invention.

FIG. 10 is a schematic block diagram illustrating the structure of an extended bitstream in accordance with a second embodiment of the present invention.

FIG. 11 is a schematic block diagram illustrating the structure of an extended bitstream in accordance with a third embodiment of the present invention.

FIG. 12 is a schematic block diagram illustrating the structure of an extended bitstream in accordance with a fourth embodiment of the present invention.

FIG. 13 is a schematic block diagram illustrating the structure of an extended bitstream in accordance with a fifth embodiment of the present invention.

FIG. 14 is a schematic block diagram illustrating the structure of an extended bitstream in accordance with a sixth embodiment of the present invention.

FIG. 15 is a schematic block diagram illustrating the structure of an extended bitstream in accordance with a seventh embodiment of the present invention.

FIG. 16 is a schematic block diagram illustrating the structure of an extended bitstream in accordance with a eighth embodiment of the present invention.

FIG. 17 is a block diagram illustrating an encoder in accordance with an embodiment of the present invention.

FIGS. 18-57 illustrate partial decoder descriptions in accordance with embodiments of the present invention.

FIG. 58 is a schematic block diagram illustrating the structure of a decoding processing unit in accordance with a third embodiment of the present invention.

FIG. 59 is a schematic block diagram illustrating the structure of a decoding processing unit in accordance with a forth embodiment of the present invention.

### MODE FOR INVENTION

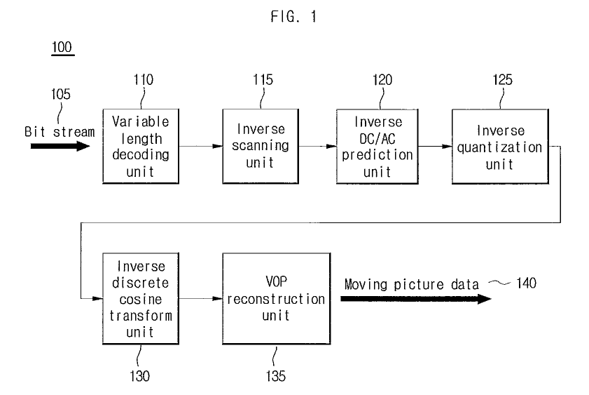

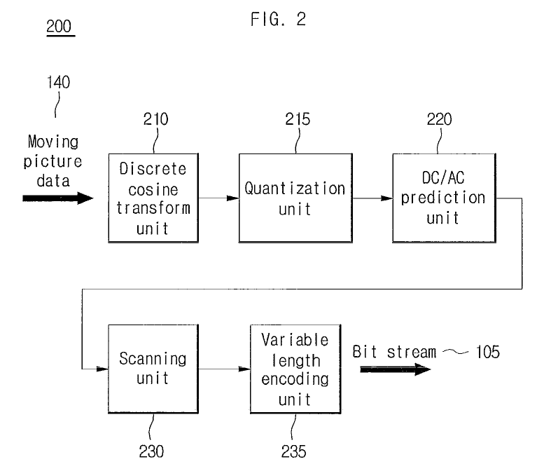

FIG. 1 is a schematic block diagram illustrating the structure of a typical decoder, and FIG. 2 is a schematic block diagram illustrating the structure of the typical encoder.

As illustrated in FIG. 1, an MPEG-4 decoder 100 typically includes a variable length decoding processing unit 110, an inverse scanning unit 115, an inverse DC/AC prediction unit 120, an inverse quantization unit 125, an inverse discrete cosine transform unit 130 and a VOP reconstruction unit 135. It shall be evident that the decoder 100 can have a structure changed depending on an applying standard and some elements can be replaced with other elements.

If a transferred bitstream 105 is syntax-parsed and corresponding header information and encoded video data are extracted, the variable length decoding processing unit 110 forms a quantized discrete cosine transform (DCT) coefficient by using predetermined Huffman table, the inverse scanning unit 115 generates data having the same sequence as pertinent video data 140 by performing inverse scanning. In other words, the inverse scanning unit 115 outputs a value in inverse order of scanning by various methods. In the encoding, after performing the quantization, a scanning direction can be defined depending on the distribution of frequency range. Typically, a zig-zag scanning method can be used. However, various scanning methods per codec can be used.

Syntax parsing can be integratedly performed in the variable length decoding processing unit 110 or in an element for processing the bitstream prior to the variable length decoding processing unit 110. In this case, since the same standard is applied to the corresponding encoder and decoder, the syntax parsing is processed by a predetermined setting only, to correspond to the pertinent standard.

The inverse DC/AC prediction unit 120 determines the direction of a reference block for prediction by using the size of the DCT coefficient at a frequency range.

The inverse quantization unit 125 performs the inverse quantization of inverse-scanned data. In other words, the inverse quantization unit 125 returns DC and AC coefficients by using a quantization parameter (QP) designed in an encoding process.

The inverse discrete cosine transform unit 130 calculates an actual video data pixel value to generate a video object plane (VOP) by performing inverse discrete cosine transform.

The VOP reconstruction unit 135 decodes a video signal by using the VOP generated by the inverse discrete cosine transform unit 130 and outputs the decoded signal.

As illustrated in FIG. 2, an MPEG-4 encoder 200 typically includes a discrete cosine transform unit 210, a quantization unit 215, a DC/AC prediction unit 220, a scanning unit 230 and a variable length encoding unit 235.

Each element included in the encoder 200 performs the inverse functions of the corresponding elements of the decoder 100. This is well-known to those of ordinary skill in the art. Briefly describing, the encoder 200 converts a video signal (i.e. a digital video pixel value) to a frequency value through the DCT and the quantization and performs the encoding. Then, the encoder 200 performs variable length encoding to differentiate bit length according to the frequency number of information and outputs compressed bit stream format.

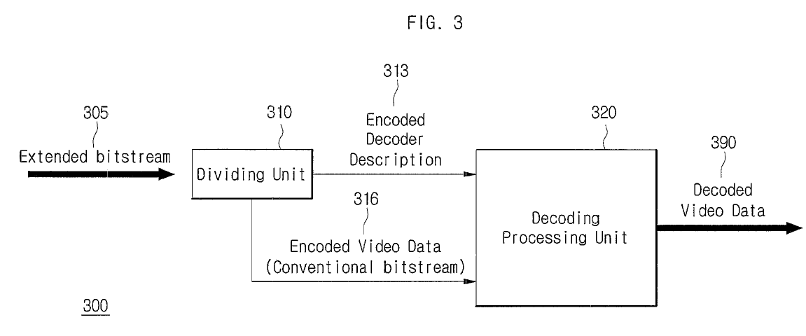

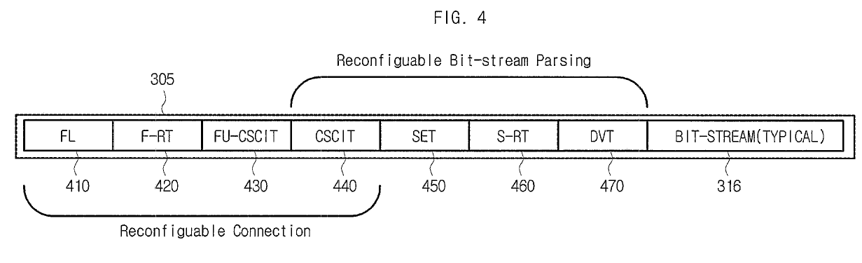

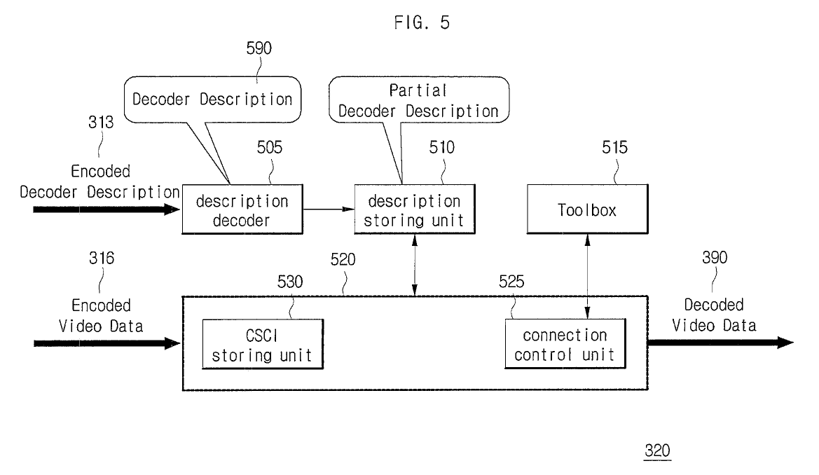

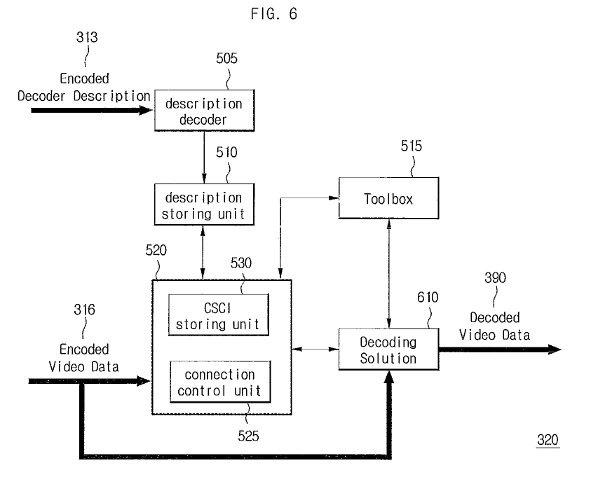

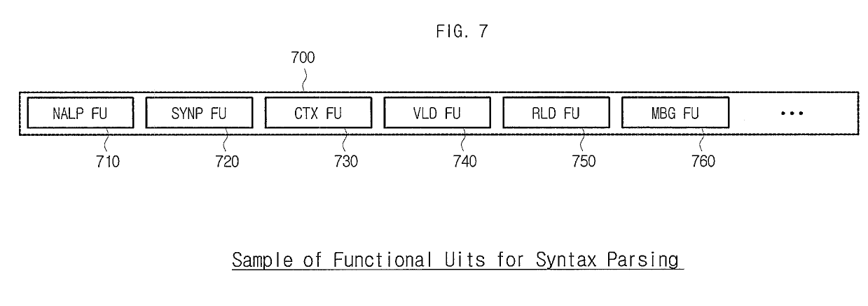

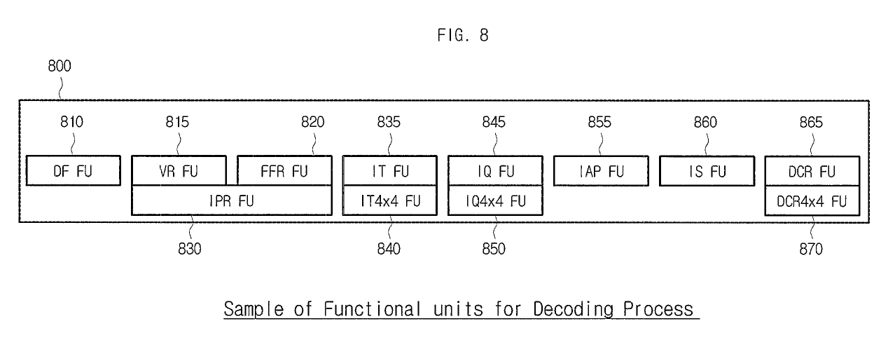

FIG. 3 is a schematic block diagram illustrating the structure of a decoder in accordance with an embodiment of the present invention, FIG. 4 is a schematic block diagram illustrating the structure of an extended bitstream in accordance with an embodiment of the present invention, FIG. 5 is a schematic block diagram illustrating the structure of a decoding processing unit in accordance with the first embodiment of the present invention, FIG. 6 is a schematic block diagram illustrating the structure of a decoding processing unit in accordance with the second embodiment of the present invention, FIG. 7 illustrates function units for syntax (SYN) parsing in accordance with the embodiment of the present invention, and FIG. 8 illustrates function units for decoding processing in accordance with an embodiment of the present invention.

As illustrated in FIG. 3, the decoder 300 of the present invention has a different function from the conventional decoder (refer to FIG. 1).

The decoder description and bitstream are provided together to the decoder 300 for encoding and decoding processing in accordance with the present invention. The decoder description can be provided to the decoder 300 as the extended bitstream implemented with the bitstream or as independent data. If the information corresponding to the decoder description is memorized in a certain memory unit decoder description can not be provided. However, hereinafter the case that the decoder description is provided to the decoder 300 will be explained.

The decoder 300 in accordance with the embodiment of the present invention includes a dividing unit 310 and decoding processing unit 320. It shall be obvious that at least one of the illustrated elements (e.g. the dividing unit 310, the decoding processing unit 320 and its elements) can be realized as a software program (or the combination of program codes) embodied for performing a function to be described below.

The dividing unit 310 divides an inputted extended bitstream 305 into an encoded decoder description (DD) part and a typical bitstream (hereinafter, referred to as a conventional bitstream) part and outputs the encoded decoder description and the conventional bitstream to the decoding processing unit 320. The dividing unit 310 can output the encoded decoder description to a description decoder 505 and outputs the conventional bitstream to a decoder implementation unit 520. As mentioned above, it the encoded decoder description and the conventional bitstream are received independently the dividing unit 310 can be omitted. The conventional bitstream can be the same or similar format of the bitstream 105 of FIG. 1.

An example of the extended bitstream 305 is illustrated in FIG. 4. As illustrated in FIG. 4, the extended bitstream 305 can include the decoder description 313 and the conventional bitstream 316. It is obvious that the extended bitstream 305 and the encoded decoder description 313 are not restricted by the examples in FIG. 4, which is to explain one of embodiments of the present invention.

The decoder description 590 that is decoded by the description decoder 505 is related to the structure information and encoding method (or the connection between functional units) of the conventional bitstream 316 and information of input/output data of functional units, in order to parse a bitstream, encoded by various encoding methods and/or by a function selected by a user among diverse functions by a common analyzing method. The decoder description 590 can be described by using a description method such as textual description or binary description. The decoder description can be omitted if the encoded decoder description 310 can be directly read by decoder implementation unit 520 without the processing of the description decoder 505.

The decoder description 590 can be divided into partial decoder descriptions that are a functional unit list (FL) 410, a functional unit rule table (F-RT) 420, a functional unit CSCIT (FU-CSCIT) 430, a control signal and context information table (CSCIT) 440, a syntax element table (SET) 450, a syntax-rule table (S-RT) 460 and a default value table (DVT) 470 and then can be memorized in description storing unit 510. It is obvious that the order of each the partial decoder descriptions for forming the decoder description can be variously changeable.

Here, the FL 410, the F-RT 420, the FU-CSCIT 430 and the CSCIT 440 can be used in order to set the connection of each functional unit (the corresponding partial decoder descriptions can be referred to as a ‘a first decoder description’).

Among them, the FU-CSCIT 440 can be the partial decoder description for the mapping between each functional unit for decoding process in a Tool box 515 and element information stored in a CSCI storing unit 530. In this case, the element information can function as a control variable for each functional unit which is for decoding processing and/or syntax parsing are in the Tool box 515 and/or a parsing functional unit.

Beside that, the CSCIT 440, SET 450, the S-RT 460 and the DVT 470 can be used for the parsing of the conventional bitstream 316 (the corresponding table can be referred to as a ‘second decoder description’). The structure and function of each partial decoder description will be described below in detail.

The description decoder 505 decodes the encoded decoder description 313 and then generates decoder description 314 and then divides the decoder description 314 into a plurality of partial decoder descriptions and outputs the partial decoder descriptions to description storing unit 510 so that the description storing unit 510 stores them.

The partial decoder descriptions are not need to be tables of general format if the partial decoder descriptions are the information of which formats can be recognized by a decoding solution 610.

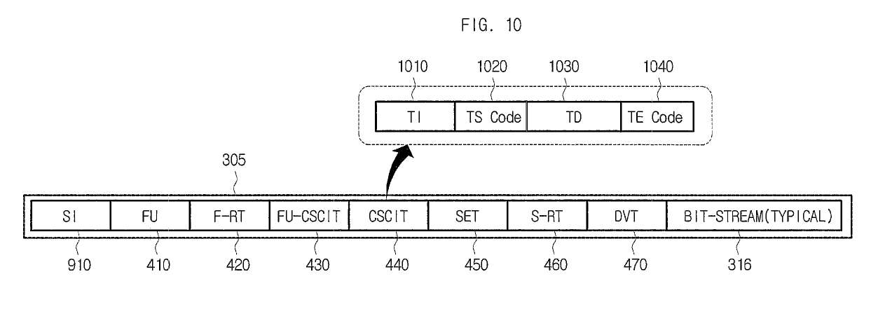

The partial decoder descriptions stored in the description storing unit 510 by the decoder description analysis of the description decoder 505 can include the FL 410, the F-RT 420, the FU-CSCIT 430, CSCIT 440, the SET 450, the S-RT 460 and the DVT 470. The description decoder 505, as illustrated in FIG. 10, can identify each partial decoder description table by referring to a table identifier (IT) 1010.

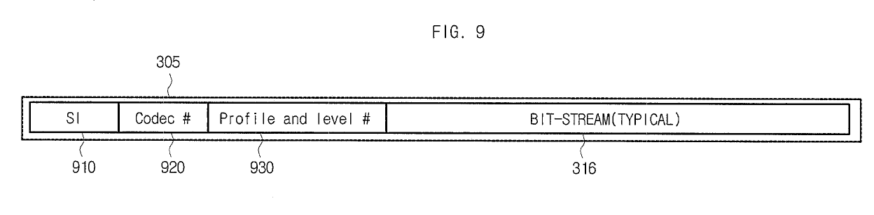

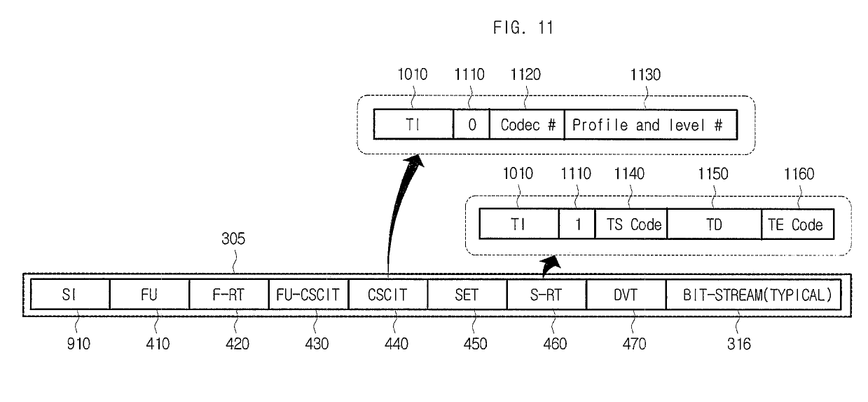

Of course, it is not necessary that all partial decoder descriptions must be stored in the decoder description. As illustrated in FIG. 9, the decoder description can include a codec number (codec #) 920. Alternatively, as illustrated in FIG. 11, only some partial decoder descriptions of the decoder description can include a codec number 1120 and a profile and level number 1130. In the case of including the codec number and the profile and level number, the description decoder 505 can generate no new partial decoder description for overall tables or some partial decoder descriptions and select a corresponding partial decoder description of the pre-stored partial decoder descriptions so as to be used when decoding.

Of course, in the case of including the codec number and the profile and level number and changing information, the description decoder 505 can extract a partial decoder description corresponding to the pertinent codec from the pre-stored partial decoder descriptions and apply the changing information to the selected partial decoder description to generate a new partial decoder description. In the meantime, in the case of including no codec number and no profile and level number but including the table description for generating a partial decoder description, the description decoder 505 can generate a partial decoder description for the overall partial decoder descriptions or some partial decoder descriptions so as to be used when decoding.

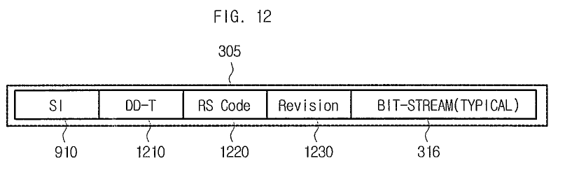

Beside that, the decoder description, as illustrated in FIG. 12, can further include not only a decoder description for each partial decoder description (DD-T) 1210 but also revision information 1230. The structure of each extended bitstream will be described in detail below with referent to the pertinent drawings.

The description storing unit 510 stores each partial decoder description divided by the description decoder 505. Of course, in case that the extended bitstream 305 includes the codec number 920 or 1120 and the profile and level number 930 or 1130, at least one partial decoder description can be stored in advance so as to be used by the decoder implementation unit 520 or decoding solution 610.

Embodiments of the decoding processing unit 320 are illustrated in FIG. 5 and FIG. 6.

As illustrated in FIG. 5, the first embodiment of the decoding processing unit 320 can include a description decoder 505, a description storing unit 510, a toolbox 515, and decoder implementation unit 520. The decoder implementation unit 520 can include a control signal/context information (CSCI) storing unit 530 and a connection control unit 525. The decoder implementation unit 520 can additionally include working memory (not illustrated) that can be used for loading and operating functional units by calling of the connection control unit 525.

The second embodiment of the decoding processing unit 320 is illustrated in FIG. 6.

As compared to the decoding processing unit 320 in FIG. 5, the second embodiment of the decoding processing unit 320 in FIG. 6 includes a decoding solution 610 additionally. The decoding solution 610 can be a work memory for operating the predetermined process of functional units that are loaded by the calling of the connection control unit 525.

As illustrated in FIG. 5 and FIG. 6, the decoder 300 of the present invention selectively loads functional units and operates decoding process. Therefore, a decoder that can decode input bitstreams of which encoding formats are diverse can be reconfigured and generated by the present invention.

As mentioned above, the present invention has an advantage that many different types of toolbox can be applied without changing design structures of other elements of a decoder because the toolbox 515 in decoder 300 of the present invention can be implemented with separating from other elements.

For example, even though a decoder was implemented for using toolbox for decoding process of MPEG standard, the decoder can replace the toolbox for decoding process of MPEG standard by the toolbox for non-MPEG decoding process or for customized decoding process by users.

The function and operation of each element of the decoding processing unit 320 will be explained below with referent to pertinent figures.

The description decoder 505 decodes the encoded decoder description 313 and has the description storing unit 510 store the decoder description.

The toolbox 515 includes functional units realized to perform each predetermined function. Here, a parsing functional unit that is implemented by one functional unit or the combination of several functional units can be include in toolbox 515 or in decoding solution 610. The parsing functional unit or other functional units can be realized by the software program.

Functional units which are formed in the successive connection by being loaded in work memory (i.e. decoder implementation unit 520 or decoding solution 610) according to the connection control of the connection control unit 525 decodes encoded video data, included in the conventional bitstream 316 into moving picture data.

Of course, the parsing functional unit can be included in the decoding solution 610 and can be set to perform the analysis of the conventional bitstream 316 according to the control of the connection control unit 525. This is because the following functional units can use the element information, analyzed and stored in the CSCI storing unit 530 by the parsing functional unit, and/or the moving picture having a macro block size, outputted from the parsing functional unit.

The parsing functional unit analyzes an inputted conventional bitstream 316 by being loaded under the control of the connection control unit 525 and stores element information, which is the result of the syntax parsing, in the CSCI storing unit 530. For example, the CSCI storing unit 530 can be a buffer memory, and the element information can be control signal/context information (CSCI). The element information, parsed by the parsing functional unit and stored in the CSCI storing unit 530, can be a parsing result value of the corresponding step and simultaneously an input value determining the following syntax of the conventional bitstream.

The parsing functional unit also performs the entropy decoding of the header of the syntax-parsed conventional bitstream 316 and video data and outputs moving picture data having a predetermined macro block size to the following functional unit according to the connection control of the connection control unit 525.

Of course, the parsing functional unit can store the moving picture data having the macro block size in the predetermined buffer memory, and the following functional unit can read and process the moving picture data having the macro block size in the corresponding buffer memory, and then, the processed moving picture data can be stored in the corresponding buffer memory for the processing of the following functional unit.

In other words, it shall be obvious that the parsing functional unit can store the moving picture data having the macro block size in the CSCI storing unit 530 or in an additional buffer memory, and then, the connection control unit 525 can provide the stored moving picture data having the macro block to a selected functional unit, or the selected functional unit can read the pertinent moving picture data from the CSCI storing unit 530 or the additional buffer memory. However, the below description assumes that the moving picture data having the macro block size, outputted by the parsing functional unit, is inputted into the functional unit according to the connection control of the connection control unit 525.

The parsing functional unit can be realized as a software program (the combination of program codes). This is because although the parsing functional unit is embodied to perform a plurality of functions corresponding to a plurality of standards (e.g. MPEG-1/2/3/ABC), respectively, the corresponding operation can be carried out by using the partial decoder descriptions. Alternatively, it is obvious that the parsing functional unit, as illustrated in FIG. 7, can be realized by dividing it into a plurality of functional units or realized as the combination of program codes blocked with each functional unit.

Below is described the function of the parsing functional unit by explaining each functional exampled in FIG. 7 in detail.

As exampled in FIG. 7, the parsing functional unit can includes a network abstraction layer parsing (NALP) FU 710, a syntax parsing (SYNP) FU 720, a context determination (CTX) FU 730, a variable length decoding (VLD) FU 740, a run length decoding (RLD) FU 750 and a macro block generator (MGB) FU 760.

Of course, the parsing functional unit can include any functional unit for the syntax parsing regardless of the applied standard. Beside that, it is shall be obvious that the functional unit necessary for the syntax parsing in the technology developing operation can newly be added, the existing functional unit can be changed and the unnecessary functional unit can be removed. It is also obvious that each functional unit equipped in the parsing functional unit can be as one functional unit in case that the functional units is not independently provided and is able to be identically processed regardless of the corresponding standards. Since the function of each functional unit is well-known to those of ordinary skill in the art, the function will be briefly described below.

The NALP FU 710 parses the network abstraction layer of the MPEG-4 AVC, and the SYNP FU 720 parses the syntax of a bitstream. The SYNP FU 720 can be included in the VLD FU 740.

The CTX FU 730 determines a VLC table of the MPEG-4 AVC, and the VLD FU 740 performs the entropy decoding.

The RLD FU 750 performs the entropy decoding of AC values, and the MBG FU 760 couples DC values and AC values to generate one macro block datum. The overall or some functional units can be included in the VLD FU 740 according to a system realizing method.

As described above, the parsing functional unit can be realized as a software program or a plurality of software programs. The operation, which the parsing functional unit extracts or generates element information by using first description information and stores the extracted or generated element information in the CSCIT storing unit 530, will be described in detail in the description related to the connection control unit 525.

The Tool box 515 decodes moving picture data in macro block units, inputted from the parsing functional unit (or stored in a buffer memory by the parsing functional unit) and outputs it as moving picture data having a predetermined size.

The Tool box 515 can include a functional unit for performing the aforementioned function corresponding to each standard. Each of functional units can be embodied as an independent processing block (e.g. a software program, the combination of command codes and a function) to form the Tool box 515. Alternatively, the Tool box 515 can be realized as one unified processing block. It shall be obvious that the Tool box 515 can perform the identical processing according to the connection control of the connection control unit 525 in spite of being realized as one unified processing block.

Decoding functional units, as illustrated in FIG. 8, includes a de-blocking filter (DF) FU 810, a VOP reconstructor (VR) FU 815, a frame field reordering (FFR) FU 820, an intra prediction and picture reconstruction (IPR) FU 830, an inverse transform (IT) FU 835, an inverse quantization (IQ) FU 845, an inverse AC prediction (IAP) 855, an inverse scan (IS) FU 860 and a DC reconstruction FU 865.

An IT4×4 FU 840, an IQ4×4 FU 850 and the DCR4×4 FU 870 process a block having a 4×4 size. This is because data having an 8×8 block size is processed in the transform, quantization and prediction in the case of MPEG-1/2/4, while there is a case that data having a 4×4 block size are processed in the case of MPEG-4 AVC.

The Tool box 515 can include any functional unit for the syntax parsing regardless of the applied standard. Beside that, it is shall be obvious that the functional unit necessary for the syntax parsing in the technology developing operation can newly be added, the existing functional unit can be changed and the unnecessary functional unit can be removed. For example, in the case of additionally requesting the IS4×4 FU processing the data having the 4×4 block size for decoding processing, the pertinent functional units can be added to the Tool box 515. Alternatively, a special prediction (SPR) FU (not shown) for performing the intra prediction in MPEG-4 AVC can be added.

It is also obvious that each functional unit equipped in the Tool box 515 can be as one functional unit in case that the functional units is not independently provided and is able to be identically processed regardless of the corresponding standards. Since the function of each functional unit is well-known to those of ordinary skill in the art, the function will be briefly described below.

The DF FU 810 is the de-blocking filter of MPEG-4 AVC, and the VR FU 815 stores a recovered pixel value.

The FFR FU 820 is the functional unit for an interlaced mode, and the IPR FU 830 performs the intra prediction of MPEG-4 AVC, and then, stores the recovered pixel value. As described above, the intra prediction of MPEG-4 AVC can be performed by the SPR functional unit.

The IT FU 835 performs the inverse transform of the DC values and AC values, and the IQ FU 845 performs the inverse quantization of the AC values.

The IAP FU 855 performs the inverse AC prediction of the AC values, and the IS FU 860 performs the inverse scan of the AC values. The DCR FU 865 performs the inverse prediction and the quantization of the DC values.

It is not necessary that each operation of the aforementioned parsing functional unit and decoding functional units must be successively performed (i.e. the decoding functional unit starts to function after the parsing functional unit completes to function). It is also obvious that each operation of the aforementioned parsing functional unit and the decoding functional unit can be performed in parallel by a plurality of functional units being loaded in work memory at the same time. This is because it can be sufficient that only minimum element information necessary for the operation of the functional unit currently operated by the Tool box 515 is stored in the CSCI storing unit 530, for example.

It is also obvious that the parallel processing of syntax parsing and decoding process is possible without any control of the connection control unit 525 in case that the decoding solution 610 includes the parsing functional unit or more than two work memories are embodied.

The CSCI storing unit 530 stores element information (e.g. CSCI), which is the result value by the syntax parsing that is performed by the parsing functional unit using the partial decoder description so as to correspond to the CSCIT 440. For example, the CSCI storing unit 530 can be a buffer memory.

The element information, stored in the CSCI storing unit 530, can be used as input data for performing the process of the SET 450 by the parsing functional unit or as a control variable for determining the following connection index in the S-RT 460.

The element information, stored in the CSCI storing unit 530, can be also used as a control variable for determining the following connection index in the F-RT 420 by the connection control unit 525 or can be used for mapping the input CSCI of a specific functional unit to the element information, stored in the CSCI storing unit 530, in the FU-CSCIT 430.

In other words, the element information, stored in the CSCI storing unit 530, allows the parsing functional unit and the decoding functional units to be linked to each other.

The connection control unit 525 sets the connection of each functional unit to decode a bitstream encoded by various standards by controlling selective loading of functional units. In other words, the connection control unit 525 selects necessary functional units among each functional unit included in the Tool box 515 and determines the performing order of the selected functional units. For this, the connection control unit 525 connects the pertinent functional units by using the partial decoder descriptions and allows each functional unit to decode moving picture data in macro block units by using the element information provided by the parsing functional unit.

The functions and uses of each partial decoder description will be explained by focusing on the operation of the connection control unit 525 in decoding solution 520 referring to pertinent figures.

The connection control unit 525 uses the FL 410, the F-RT 420, the FU-CSCIT 430 and the CSCIT 440 to perform the aforementioned function. Additionally, S-RT 460 can be used for setting the connection relation of each functional units for syntax parsing.

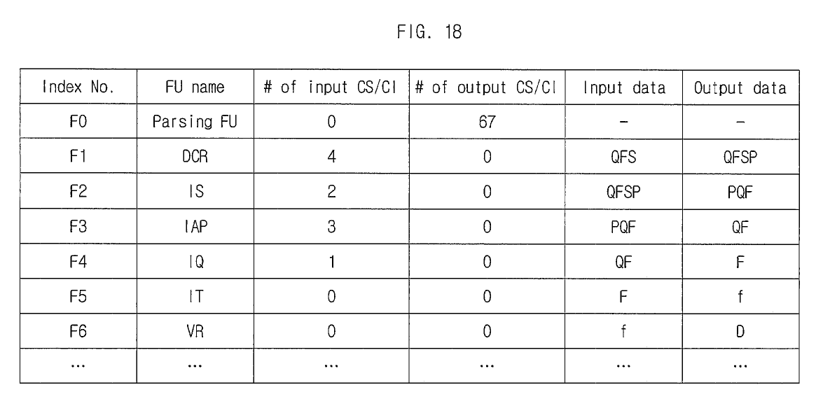

First, the FL 410, as illustrated in FIG. 18, is the partial decoder description including the list of each functional unit, equipped in the Tool box 515, input and output data of the pertinent functional units and element information controlling the functional units.

The FL 410 can further include a buffer memory title of input data for each functional unit (or a history address of the corresponding data or an address of the buffer memory, written with the pertinent data) and a buffer memory title of output data for the pertinent data (or a history address of the corresponding data or an address of the buffer memory, to be written with the pertinent data).

Accordingly, each functional list can read input data and write processed output data, by using the FL 410. Alternatively, the input and output data can be transferred between each functional unit, or the connection control unit 525 can provide appropriate input data to each functional unit.

However, the input data and output data of the parsing functional unit generating element information is not written in the FL 410. This is because the parsing functional unit generates the element information by using the SET 450 and writes the generated element information in a predetermined area.

The FL 410, as illustrated in FIG. 18, can include an identifier (index) for identifying each functional unit, a name of each functional unit (FU name), the number of input control (CSCI) variable necessary for the corresponding functional unit, input data and output data.

A specific functional unit, loaded in work memory by the connection control unit 525, receives input data from the connection control unit 525 and performs a predetermined process, to generate output data. Here, the functional unit refers to a series of processing operation (e.g. a task, algorithm or function) included in the Tool box 515 and performing the processing of the input data by using a predetermined process, to generate the output data. The pertinent functional unit can store the output data in the buffer memory to process the following functional unit (i.e. the functional unit followed and selected by the connection control unit). Since the functional unit exampled in FIG. 18 has already been described, the pertinent description will be omitted. Also, a QFS, a QFSP, a PQF and a QF in FIG. 18 are well-known to those of ordinary skill in the MPEG field, the corresponding description will be omitted. For example, the QFS refers to an output value performed with variable length coding.

In case it is sufficient that the decoding processing unit 320 uses one standard to decode encoded video data included in the conventional bitstream 316, the FL 410 can include only information related to the functional units for performing the processing corresponding to the pertinent standard.

However, in the case of encoding the corresponding video data by a plurality of standards (e.g. in the case of applying the encoding standard depending on a plurality of frame units), there is requested the information related to the functional units according to the plurality of standards to decode the corresponding encoded video data. Accordingly, in this case, the FL 410 must include the information related to the functional units according to the plurality of standards, necessary for the decoding of the encoded video data, among all functional units according to the corresponding plural standards.

Of course, although the video data is differently applied with the encoding standard per plurality of frame unit, if a plurality of the conventional bitstream 316 and the extended bitstream 305 are generated and outputted per applied encoded standard, it is sufficient that each FL 410 includes the information related to the functional units according to corresponding standards, respectively.

The FL 410 can be described by a describing method such as textual description and binary description (a form of a bit-converted binary code). Beside that, minimum necessary data in the partial decoder description can be described in similar script languages.

Next, the F-RT 420 provides the connection rule of the functional units to be used for the decoding of the inputted conventional bitstream 316.

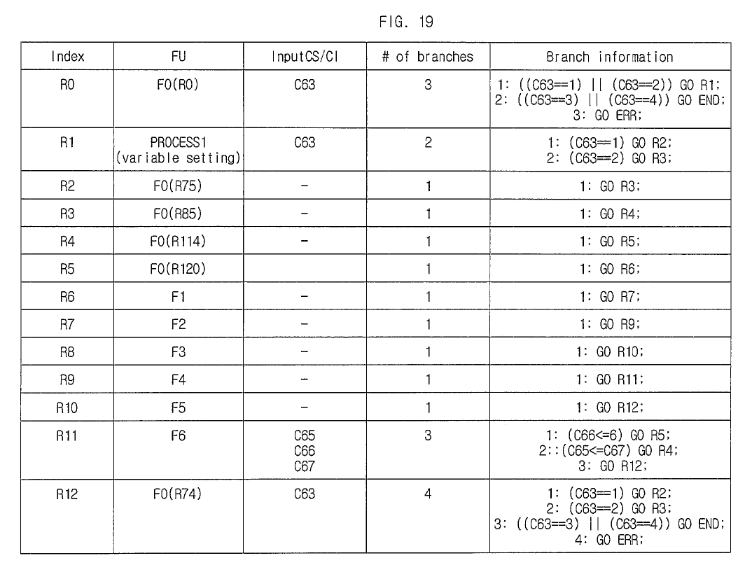

The F-RT 420, as shown FIG. 19, includes an index (R) identifying each connection rule, a functional unit (F#) corresponding to the pertinent connection index, element information (input CS/CI, C#) necessary for the connection control, the number of branches (No. of branches) capable of being connected to the following functional unit, and branch information (#1, #2, and #3) necessary as many as the branch number.

There is provided the necessary element information in case that the number of branches is 2 or more. In this case, the connection index can be varied depending on the determining result of conditional sentence using the necessary element information. In other words, if the number of branches is 1, there is no necessary element information, and the connection index, indicated by the branch information, progresses. The following connection index (R) is represented after the pertinent conditional sentence.

In case it is sufficient that the decoding processing unit 320 uses one standard to decode encoded video data included in the conventional bitstream 316, the F-RT 420 will indicate the connection of the functional units for performing the processing corresponding to the pertinent standard.

However, in the case of encoding the corresponding video data by a plurality of standards (e.g. in the case of applying the encoding standard depending on a plurality of frame units), it is obvious that the F-RT 420 includes the information for indicating the connection of the functional units according to the plurality of standards to decode the corresponding encoded video data. Accordingly, it is obvious that each partial decoder description, described below, further includes the pertinent information if the tables request additional information and/or need to be changed so as to be applied to the plurality of standards.

The F-RT 420 can be described by a describing method such as textual description and binary description (a form of a bit-converted binary code). Beside that, minimum necessary data in the partial decoder description can be described in similar script languages.

As exampled in FIG. 19, the functional unit for performing R0 through R5 and R12 is F0 among the index (R) identifying each connection rule. The F0, referring to the FL 410 of FIG. 19, is the parsing functional unit. Accordingly, the connection control 530 controls the connection of the operation of each functional unit (including the parsing functional unit) equipped in the toolbox 515. Also, in case that the selected functional unit is the parsing functional unit, the F-RT 420 includes the connection rule indicating that the parsing functional unit has to read and process n^{th} syntax (e.g. F0 (R74)).

Beside that, the index R1 is defined with ‘PROCESS1’ on the item of the functional unit. For example, ‘PROCESS1’ can be the function called to perform other operations (i.e. operations excluding syntax parsing and data decoding) necessary for programming a software such as variable declaration, memory setting and variable initialization. This kind of the process can be inserted into the necessary location of the F-RT 420 and called by the connection control unit 525 in the syntax parsing operation or in the middle of the data decoding operation, so as to be performed. Even though FIG. 18 illustrates that one process is inserted, it shall be obvious that a plurality of processes having all identical performing operations or performing operations different from each other can be inserted into a plurality of locations of the F-RT 420.

Next, the FU-CSCIT 430 is the partial decoder description for connecting the element information, stored in the CSCI storing unit, to the element information (input CSCI) necessary for each functional unit.

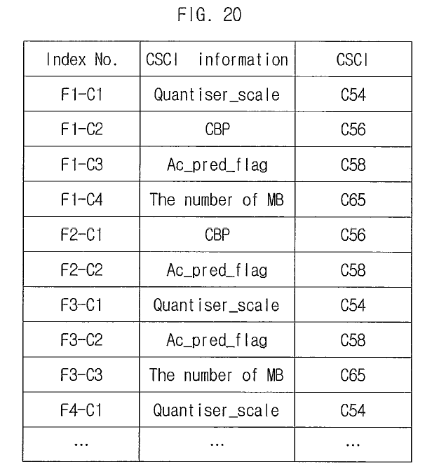

As illustrated in FIG. 20, the FU-CSCIT 430 includes an index (F-C) arranged as a pair of the index and the element information of the FL 410, corresponding element information and an index (C) used in the CSCIT 440 for the mapping. Beside that, the FU-CSCIT 430 can further include a data type of the element information. For example, the data type can be described in a form of 9-bit integer or 1-bit flag.

The FU-CSCIT 430 can be described by a describing method such as textual description and binary description (a form of a bit-converted binary code). Beside that, minimum necessary data in the partial decoder description can be described in similar script languages.

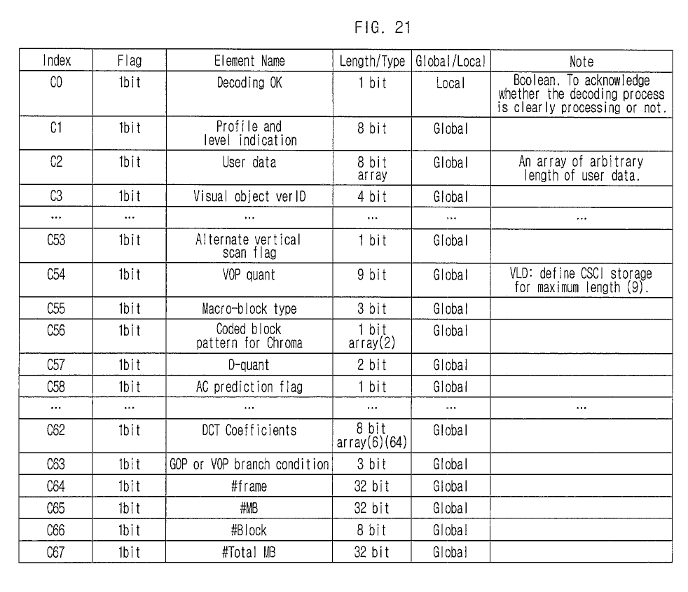

For example, if F1 receives 4 items of element information from the F-RT 420 (refer to FIG. 18), the FU-CSCIT 430 is listed with the element per functional unit. In other words, F1-C1, F1-C2, F1-C3 and F1-C4 are listed, and each element information such as C54, C56, C58 and C65 is mapped to by using the index (C) of the CSCIT 440 (refer to FIG. 21).

Similarly, if F2 receives 2 items of the element information, the FU-CSCIT 430 indexes F2-C1 and F2-C2, and C56 and C 58 are mapped to. Here, the C56 and C 58 can be recognized as the addresses stored with the corresponding element information (e.g. a history address, a buffer memory title and a history address of a buffer memory), respectively. The pertinent functional unit can generate output data by using the element information corresponding to the input data and index (C) and output (or write in the buffer memory) the generated output data.

For example, the DCR requests 4 items of element information to process input data of QFS in the FL 410, and the 4 items of element information is recognized as C54, C56, C58 and C65 by the FU-CSCIT 430. The CSCIT storing unit 530 reads the element information corresponding to the pertinent index (C) to generate QFSP.

Finally, the CSCIT 440 is described with the detailed element information (e.g. CSCI), that is, the result information of the process where the parsing functional unit use the SET 450 and the S-RT 460. In other words, the CSCIT 440 includes all meaningful data (i.e. element information), which is processed from the conventional bitstream 316, stored in the CSCI storing unit 530 and to be used by the decoding functional units.

As illustrated in FIG. 21, the CSCIT 440 includes an index (C), which is an identifier as an identity number of the pertinent information, a flag, a name (element name) of the pertinent element information, an attitude (e.g. a storing space size of the pertinent element information and whether the pertinent element information is an array type) indicating data-structural property of the pertinent element information and a global/local indicating whether the pertinent element information is used in the syntax parsing operation or overall decoding operation.

The CSCIT 440 can be described by a describing method such as textual description and binary description (a form of a bit-converted binary code). Beside that, minimum necessary data in the partial decoder description can be described in similar script languages.

Next, the CSCIT 440, the SET 450, S-RT 460 and the DVT 470, which are used in order to extract or generate the element information from the conventional bitstream 316 and store the extracted or generated element information in the CSCI storing unit 530, will be described. However, since the CSCIT 440 has already been described with reference to FIG. 20, the pertinent description will be omitted.

First, the SET 450 is a partial decoder description formed by the information related to the syntaxes of the inputted conventional bitstream.

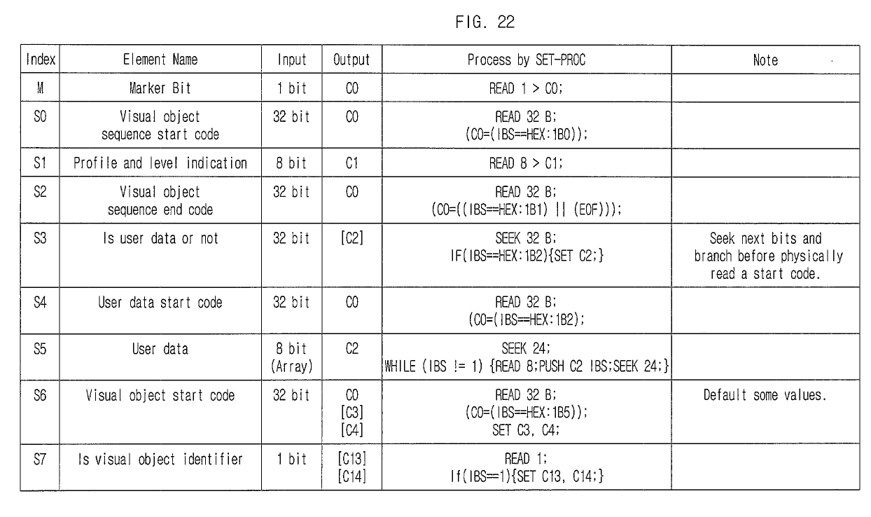

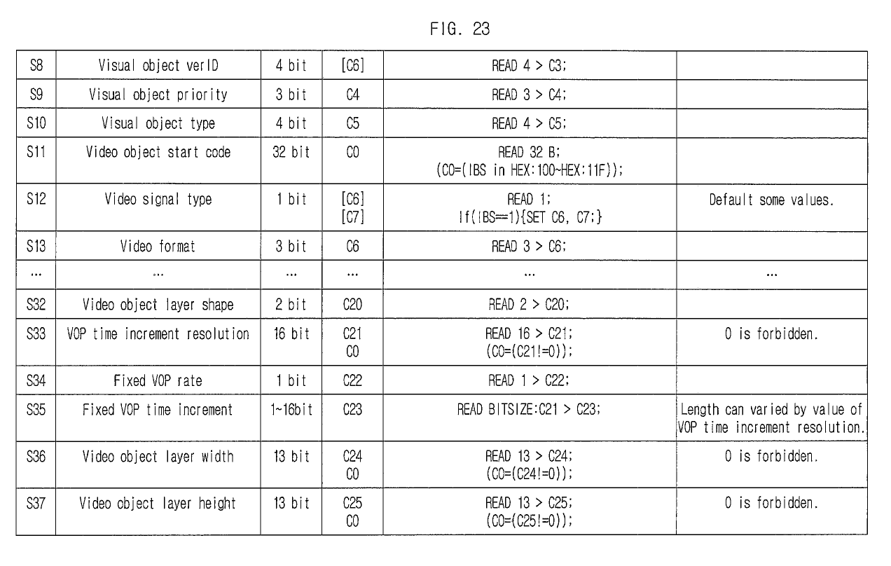

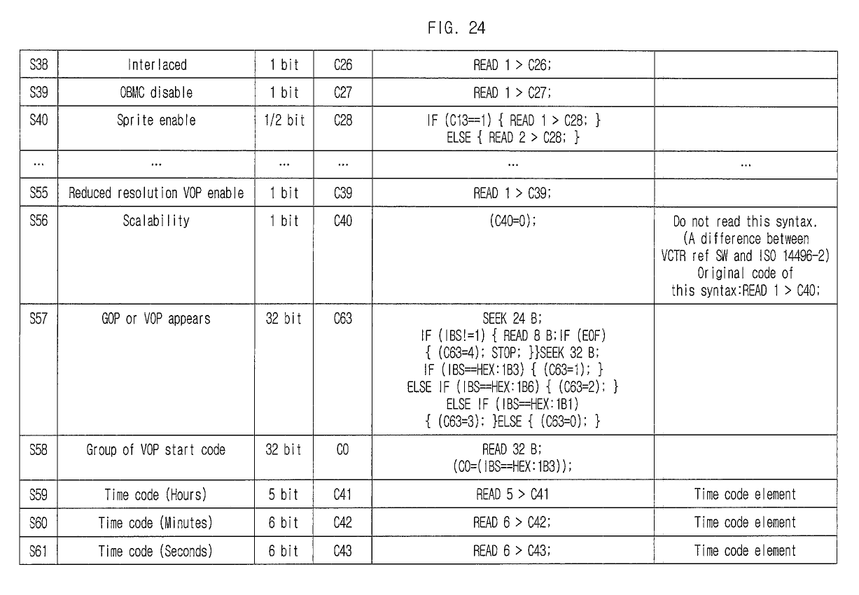

As illustrated in FIG. 22 through FIG. 25, the SET 450 includes an index of each syntax, an element name, input data, output data, and SET-process (process by SET-PROC) information. Here, the index is the identifier (S) identifying each syntax used in the S-RT 460. The element name can be named for the syntax depending on the meaning or function of the syntax. The input data refers to nominal bit length of data inputted at one time in the conventional bit stream 150. The output data indicates a list of the CSCIT 430 referred to when storing acquired data, as the element information (i.e. CSCI (C)). Here, an output data field can be the title of a buffer memory (or a history address of the corresponding data or an address of the buffer memory, written with the pertinent data) where the generated element information will be written. For this, in the case of requesting the element information as input data later, the pertinent element information can be read by using the CSCI (C). The SET-process describes the operating process, undergone after the operation receiving the syntax of each bitstream, and generating the element information as output data.

The SET 450 can be described by a describing method such as textual description and binary description (a form of a bit-converted binary code). Beside that, minimum necessary data in the partial decoder description can be described in similar script languages.

Then, the S-RT refers to the connection rule between each syntax in the conventional bitstream. In other words, the S-RT 460 includes the information calling each syntax and directing to move to the next syntax. The parsing functional unit reads the conventional bitstream 316 or defines the order of storing in the CSCI storing unit 530 and/or renewing the element information.

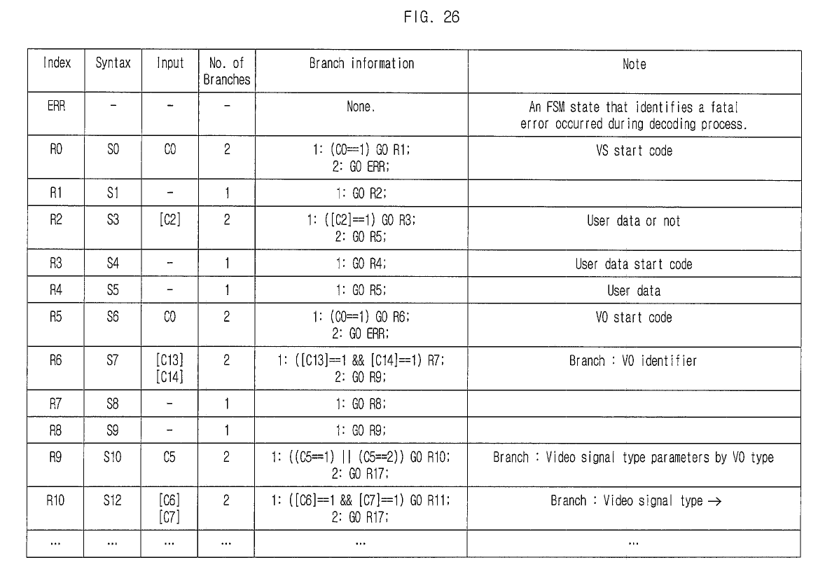

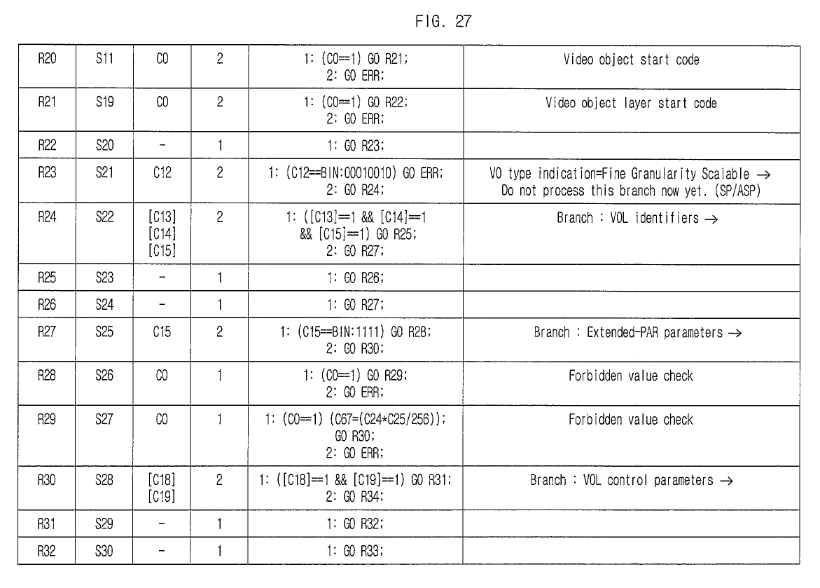

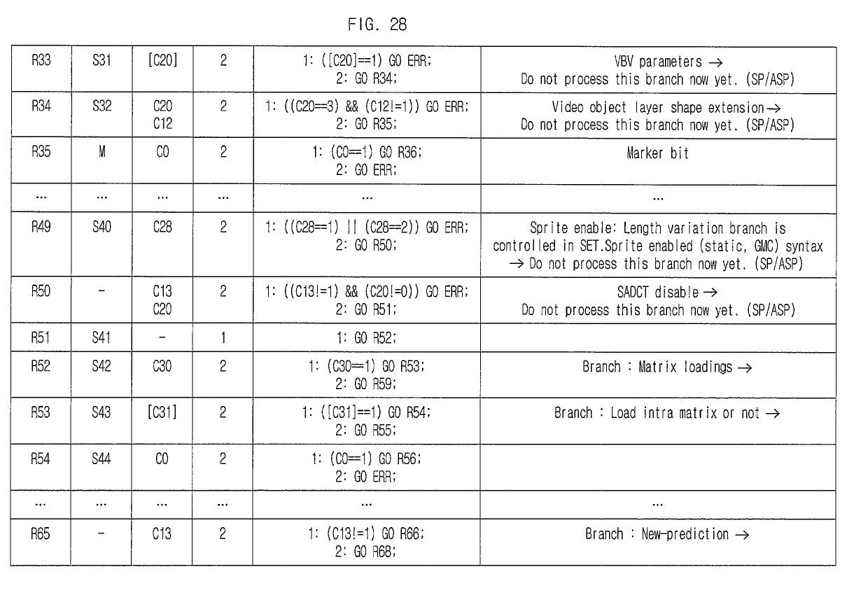

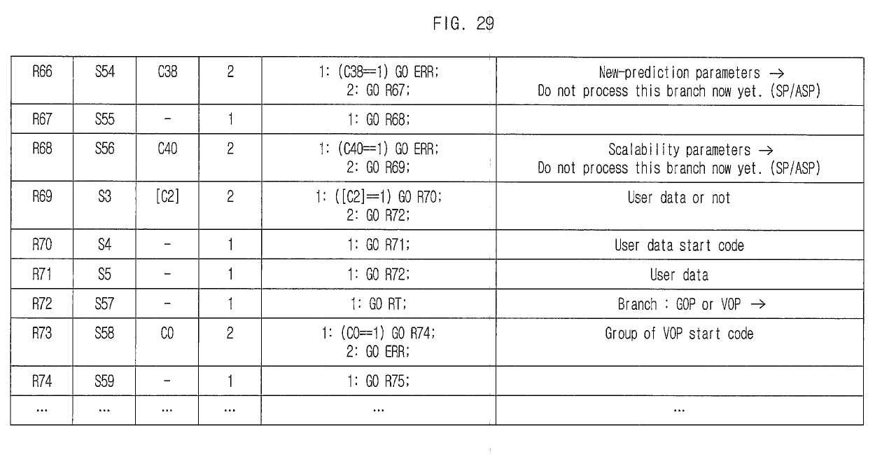

As exampled in FIG. 26 through FIG. 29, the S-RT 460 includes an index (R), an index (S) of the syntax, input data (C), the number of branches and branch information.

The index (R) identifies each connection rule. Since the index (S) of the syntax designates the syntax to be processed in a specific connection index, the parsing functional unit or the functional units for performing syntax parsing performs the predetermined process of the pertinent syntax by using the SET 450.

The input data indicates the list of the element information to be used for the conditional determination for the connection control of the pertinent connection index.

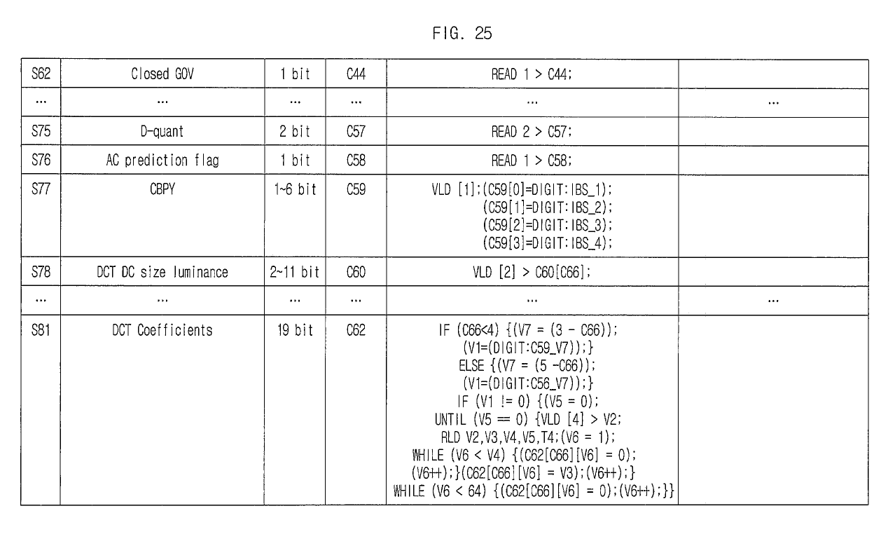

The number of branches, which is the number of cases capable of being connectable to the following syntax, indicates the total number of branch paths included in the pertinent connection index. The branch information (#1, #2, #3 . . . ), which is provided necessary as much as the number of branches, refers to the conditional determining algorithm to determine which connection index is processed next. It can be directly determined what content is read and in which order the content is read. As illustrated in FIG. 25 through FIG. 28, if the number of branches is 1, there is no input data, it directly progress to process the connection index designated by the branch information. However, in case that the number of branches is 22 or more, the condition determination is performed (it is formed by next connection rule (R) after conditional sentence), and it progresses to process the corresponding connection index.

The parsing functional unit processes the syntax defined in the pertinent connection index and renews the CSCI storing unit 530. Then, the parsing functional unit refers to and reads the element information of the renewed CSCI storing unit 530 and uses the element information for the branch conditional determination. For example, C0 in ‘C0==1’ as the branch condition of the branch information of the index R0 is the element information C0 after processing the syntax S0.

The S-RT 460 can be described by a describing method such as textual description and binary description (a form of a bit-converted binary code). Beside that, minimum necessary data in the partial decoder description can be described in similar script languages.

Finally, the DVT 470 is the partial decoder description written with Huffman table information used in each encoder/decoder. In MPEG-1/2/4/AVC, the entropy coding is performed whenever encoding, by mainly using the Huffman coding method. In this case, the used information is the Huffman table. There must be provided the Huffman table information to be used in the pertinent decoder whenever decoding, in order to realize unified codec. Accordingly, the Huffman table information corresponding to each syntax in the decoder description of the present invention is included, when syntax parsing. Of course, in case that the Huffman table information corresponding to each standard has already been written in the description storing unit 510, the transmission of the DVT 470 will be omitted or only the codec number 1120 and the profile and level number 1130 can be included as illustrated in FIG. 11.

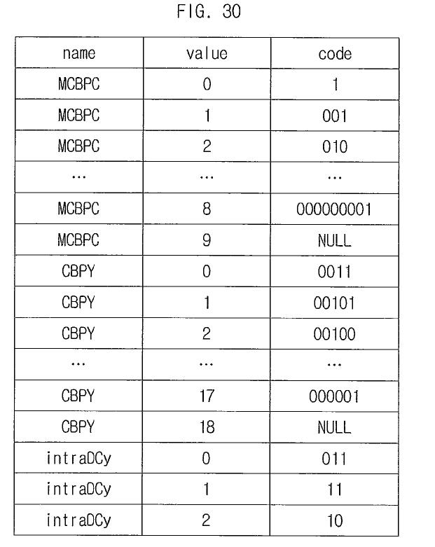

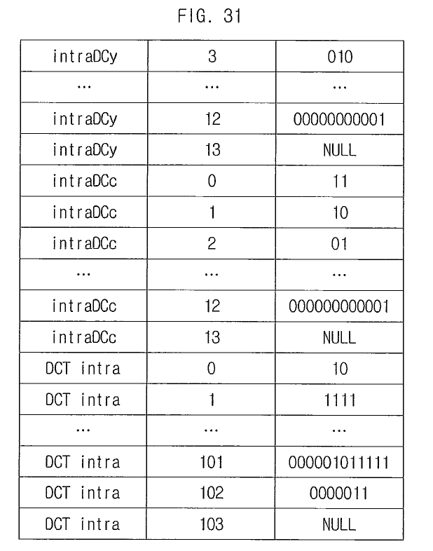

As illustrated in FIG. 30 and FIG. 31, the DVT 470 includes a name of each Huffman table, an actual value compressed by the Huffman coding and outputted and a code value when the compressed actual value is stored in the conventional bitstream 316. For example, in case that the compression of an MCBPC value leads to the actual value of 3, the code value of 011 is written in the conventional bitstream by a Huffman table mapping operation (e.g. the PROCESS of the SET 450). For another example, VLD[1] is written in the PROCESS of the index S77 (refer to FIG. 22 through FIG. 25) of the SET 450, exampled above, to call a VLD function. The code value is obtained by reading the conventional bitstream 316 as much as the length (fixed length or variable length) predetermined by this function. Then, the corresponding actual value can be obtained by the Huffman table mapping operation. At this time, the Huffman table is [1], that is, 1^{st} table of CBPY.

The DVT 470 can be described by a describing method such as textual description and binary description (a form of a bit-converted binary code). Beside that, minimum necessary data in the partial decoder description can be described in similar script languages.

For example, the DVT 470 can be described in textual description as follows.

DVT {((0,1), (1,001), (2,010), (3,011), (4,0001), (5,000001), (6,000010), (7,000011), (8,000000001), (9,NULL)) ((0,0011), (1,00101), (2,00100), (3,1001), (4,00011), (5,0111), (6,000010), (7,1011), (8,00010), (9,000011), (10,0101), (11,1010), (12,0100), (13,1000), (14,0110), (15,11), (16,000000), (17,000001), (18,NULL)) ((0,011), (1,11), (2,10), (3,010), (4,001), (5,0001), (6,00001), (7,000001), (8,0000001), (9,00000001), (10,000000001), (11,0000000001), (12,00000000001), (13,NULL)) ((0,11), (1,10), (2,01), (3,001), (4,0001), (5,00001), (6,000001), (7,0000001), (8,00000001), (9,000000001), (10,0000000001), (11,00000000001), (12,000000000001), (13,NULL)) . . .

Alternatively, the DVT 470 can be described in binary description as follows.

000000111111111111111111111111101111100001100011001000110100001 1011001000001001100000010011000001000110000011010010000000010000011111 0010000110010100101001010010000100100100101000110010001110011000001000 1001011001010001000110000011001000101001001010001000100001001000001000 1100001011001100000000011000000100000111110001101100010110001010000110 1000011001001000001001010000100110000001001110000001010000000000101001 0000000010101000000000010101100000000001000001111100010110001010000100 1000110010010000010010100001001100000010

Each partial decoder description can be described in binary description, to thereby reduce the storing space, increase the processing efficiency and decrease the transmission time of the extended bitstream included in the decoder description. For example, the below partial decoder description 1 shows the overhead bit of the textual description and the binary description for each table based on MPEG-4 SP (simple profile).

TABLE 1
Overhead of Textual/Binary Description (bytes)

| Table name | Textual Description | Binary Description |
|---|---|---|
| SET | 3,653 | 1,089 |
| S-RT | 4,201 | 1,122 |
| F-RT | 466 | 142 |
| CSCIT | 808 | 24 |
| FU-CSCIT | 151 | 37 |
| FL | 98 | 28 |
| DVT | 2,599 | 259 |
| Total | 11,976 | 2,702 |

Hereinafter, the linking operation between each partial decoder description used by the parsing functional unit and/or the connection control unit 525.

The decoding processing unit 320 of the decoder 300 in accordance with the present invention can start to be variably operated. Some of the operating methods are described below.

In a method according to a first embodiment, the connection control unit 525 monitors whether the partial decoder descriptions are stored. If they are stored, the connection control unit 525 controls connection and operation of each functional unit of the Tool box 515 by using the partial decoder descriptions stored.

As described in the example related to the F-RT 420, after first loading the parsing functional unit among the functional units in the tool box 515 such that the element information syntax-parsed with the conventional bitstream can be stored in the CSCI storing unit 530, if the control authority is returned to the connection control unit 525 (e.g. the control authority such as an index R72 of the S-RT 460 is allow to be returned to the connection control unit 525), the connection of each functional unit is controlled such that the corresponding functional unit can process the following operation.

A method according to a second embodiment is described below. The method according to a second embodiment is the method that is applicable to the case that parsing functional unit is previously loaded in the decoding solution 610 or more than two work memories are included in decoder implementation unit 520 or/and decoding solution 610.

In other words, after the parsing functional unit loaded in any work memory or the parsing functional unit in the decoding solution 610 independently starts the operation and completes syntax parsing, the connection control unit 525 recognizes it and controls the connection by selectively loading corresponding functional units.

In this case, the connection control unit 525 first has to recognize that the storing of the elements information necessary for the parsing functional unit is completed. For this, the connection control unit 525 must sustainably monitor whether to store the necessary elements information in CSCI storing unit 530, or the parsing functional unit, which stores the elements information, must notify it to the connection control unit. For example, the parsing functional unit can notify by returning the control authority into connection control unit 525 like index R72 of S-RT 460.

Of course, it shall be obvious that the connection control unit 525 (or a functional unit loaded by control of the connection control unit 525) and/or the parsing functional unit can be on standby after starting to be operate until necessary information is stored in the pertinent storing unit, without monitoring whether to store the necessary information in the description storing unit 510 or the CSCI storing unit 530.

Below is described the liking operation between each partial decoder description used by the connection control unit 525 and/or the parsing functional unit based on the aforementioned first embodiment.

First, the connection control unit 525 reads a first regulation rule of the F-RT 420 in the description storing unit 510, to call the pertinent functional unit. As shown in the F-RT 420, the connection control unit 525 reads F0(R0) firstly, and then, directs to the parsing functional unit to process it. This can be to activate a processing block of the program codes corresponding to the parsing functional unit. In the case of the FL 410, F0 can be identified as the parsing functional unit. If the selected functional unit is the parsing functional unit 450, the information (e.g. F0(R0) and F0(R114) that n^{th} syntax must be read is described together.

The parsing functional unit reads a regulation rule, designated by the connection control unit 525 (i.e. designated by the F-RT 420), of the regulation rules of the S-RT 460, to read the pertinent syntax. As described above, since the regulation designated by the F-RT 420 is F0(R0), the parsing functional unit starts to process from the index R0. The parsing functional unit recognizes that the S0 must be processed in the index of R0 by the S-RT 460 and that the S0 is the visual object sequence start code by the SET 450. Then, the parsing functional unit reads the corresponding bit (i.e. 32 bit set as the input value for the SET 450) from the conventional bitstream 316 and generates the corresponding output (i.e. C0 as the element information) to store it in the CSCI storing unit 530. The CSCIT 440 is described with what is the pertinent element information, stored in the CSCI storing unit 530.

Next, the parsing functional unit substitutes the element information (i.e. C0), stored in the CSCI storing unit 530, for branch information corresponding to the S-RT 460 and progresses the index processing corresponding to the result. For example, since the branch information corresponding to the index of R0 is ‘C0==1,’ if it is satisfied, R1 progresses. Otherwise, it is processed as an error. This operation is repeated until there is ‘GO RT’ and the control authority is transferred to the F-RT 420 (i.e. connection control unit 525) (e.g. index of R72 of the S-RT 460).

However, if the VLD function (e.g. index of S74 of the SET 450) is called in the operation that the parsing functional unit generates element information by using the SET 450 and stores the generated element information in the CSCI storing unit 530, the entropy decoding is performed by using the DVT 470. In this operation, if the element information is generated, the generated element information is stored in the CSCI storing unit 530.

If there is ‘GO RT’ in the processing operation of the parsing functional unit and the control authority is transferred to the F-RT 420 (i.e. connection control unit 525) (e.g. index of R72 of the S-RT 460), the connection control unit 525 reads C 64, that is, the input value of the index of R0 (i.e. element information according to the index of S57 of the SET 450 in the syntax parsing operation) from the CSCI storing unit 530 and designates a next index to be processed by substituting it for branch information (i.e. ((C63==1)∥(C63==2)) or ((C63==3)∥(C63==4))). In other words, it is determined in accordance with whether it satisfies the branch information that the index of R1 progresses, it is ended or it is processed as an error.

If the R1 progresses, a predetermined processing (e.g. variable declaration, memory setting and variable initialization) is performed, and then, the next index to be processed is determined.

As described above, if some/overall element information is stored in the CSCI storing unit 530 by the processing of the parsing functional unit, the connection control unit 525 calls the functional unit of F1 in the index of R6. F1 is identified as the DC reconstruction (DCR).

The DCR recognizes 4 input values (i.e. C54, C56, C58 and C65) by referring to the FU-CSCIT 430 and reads the element information from the CSCI storing unit 530. It can be recognized through the mapping to the CSCIT 440 what is the pertinent element information. The DCR completes the processing of the moving picture data having a predetermined macro block size for the pertinent functional unit by using the read element information and stores the processed moving picture data in the buffer memory or the CSCI storing unit 530.

This kind of operation is repeated form the index of R6 to R11 of the F-RT 420. Accordingly, the DCR, IS, IAP, IQ, IT and VR are controlled so as to be successively connected. The connection control unit 525 can recognize whether an arbitrary functional unit completes the processing. If the processing of the pertinent functional unit is completed, the processing of the following functional unit is directed to be processed. Beside that, the corresponding functional unit stores the processed data in a predetermined buffer memory or the CSCI storing unit 530, for the processing of the moving picture data of the following functional unit. The method that the connection control unit 525 recognizes whether an arbitrary functional unit completes the processing is well-known to those of ordinary skill in the art, the pertinent description will be omitted.

The decoding processsing unit 320 can output moving picture data corresponding to the inputted conventional bitstream 316 by controlling the connection control unit 525 to perform the aforementioned operation, that is, the index order described in the F-RT 420 and/or the index order according to the branch condition.

As understood through the aforementioned description, a linking loop between the decoder descriptions of the present invention can be roughly divided into 2 loops. In other words, a F-RT loop consists of the F-RT 420, the FL 410, the FU-CSCIT 430, the CSCIT (branch condition applying) and the F-RT (next rule), and an S-RT consists of the S-RT 460, the SET 450, the CSCIT 440, the S-RT 460, the CSCIT (branch condition applying) and the S-RT (next rule).

Also, the F-RT loop can be divided into 2 loops as follows. First, in the case of directing the performance of parsing functional unit, the F-RT loop consists of the F-RT 420, the FL 410, the FU-CSCIT 440, F-RT 420, the CSCIT (branch condition appliance) and the F-RT (next rule). In the case of directing the performance of the parsing functional unit, the F-RT loop consists of the F-RT 420, the FL 410, (the S-RT loop), the F-RT 420, the CSCIT (branch condition applying) and the F-RT (next rule).

Similarly, the S-RT loop can be divided into 2 loops as follows. In the case of the branching by using the next regulation rule, the S-RT loop consists of the S-RT 460, the SET 450, the CSCIT 440, the S-RT 460, the CSCIT (branch condition applying) and the S-RT (next rule). In the case of returning to the F-RT 420, the S-RT loop consists of the S-RT 460, the SET 450, the CSCIT 440, the S-RT 460, the CSCIT (branch condition applying) and the F-RT (the index of the called F-RT 420). The connection of each functional unit equipped in the toolbox 515 by the connection control of the connection control unit 525 according to the F-RT 420 becomes different.

Below is described a command forming each partial decoder description in detail.

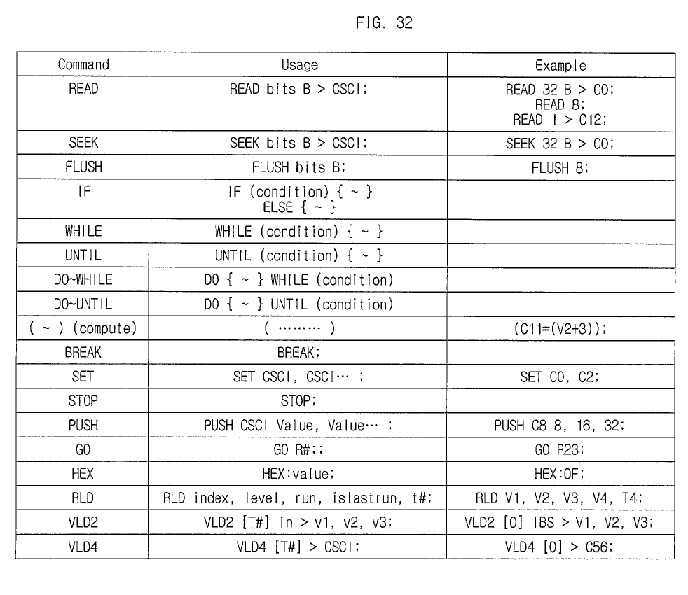

FIG. 32 illustrates a command used in each partial decoder description for the syntax parsing. The information (i.e. partial decoder description) for parsing the syntax of the standard such as MPEG-2/MPEG-4/MPEG-4 AVC can be formed by using each illustrated command. Hereinafter, the example of the partial decoder descriptions for parsing the MPEG-2 MP (main profile) intra coded syntax will be described based on the linking between each partial decoder description.

As illustrated in FIG. 32, there are provided READ, SEEK, FLUSH, IF, WHILE, UNTIL, DO˜WHILE, DO˜UNTIL, BREAK, SET, STOP, and PUSH as a command for forming each partial decoder description. Of course, it is not necessary that all commands must be used in each partial decoder description. It shall be obvious that a specific command can be selectively used per partial decoder description. Below is briefly described the usage of each command.

First, READ is the command for reading a specific bit from the bitstream. For example, it is represented by the way of “READ bits B>CSCI;” Here, “bits” refers to the number of bits to be read, “B” refers to the byte-alignment. “>CSCI” refers to the CSCI index to be stored. The “B” and “>CSCI” are used as an option. If the “>CSCI” is not designated, it is set to store it in an only variable IBS.

Then, SEEK is the command reading a specific bit from the bitstream but allowing a file pointer not to move. The file pointer refers to the reference location in the operation such as reading a specific bit. A parameter of the seek command can be applied as the same as the READ.

The FLUSH is the command moving the file pointer as much as the number of bits. Its parameter can be applied similarly to the READ.

The IF, which can be used in a form of “IF (condition) {˜} ELSE {˜},” is the command providing the branch according to the given condition.

The WHILE, which can be used in a form of “WHILE (condition) {˜},” is the command repeating the designated block while the given condition is true.

The UNTIL, which can be used in a form of “UNTIL (condition) {˜},” is the command repeating the designated block until the given condition is true.

The DO˜WHILE, which can be used in a form of “DO {˜} WHILE (condition),” is the command changing the WHILE sentence and performing the designated block before the conditional determination.

The DO˜UNTIL, which can be used in a form of “DO {˜} UNTIL (condition),” is the command changing the WHILE sentence and performing the designated block before the conditional determination.

The command of (˜) (compute) is used in a form of “(C11=(V2+3));”. In other words, all calculations of SET-PROC can be written in parentheses, and an operator for 4 fundamental rules of arithmetics, substitution, addition/subtraction (++/−−), bitwise operation, logical sum/logical multiply and check of whether to use the CSCI.

The BREAK is the command breaking away from the closest loop structure.

The SET is the command setting a flag for determining whether to use the designated CSCI. The CSCI that will designate the flag can be arranged and be identified by a comma (,), (for example, SET C0, C2;).

The STOP is the command stopping the processing of the syntax element currently performed and performing a next processing.

The PUSH is the command adding given data from the end area written with data. The added values are arranged (e.g. PUSH C8 8, 16, 32;) and identified by the comma.

The GO is the command branching to the designated location. For example, the GO R#; is the command branching to R#, and the GO RT is the command returning to a called location.

The HEX is the command indicating that a hexadecimal value follows the command of the HEX.

The RLD, which is the interface for an RLD function supported in MPEG-4, can be used in a fond of “RLD index, level, run, islastrun, t#;” Here, the index, level, run and islastrun refers to an internal variable and CSCI, storing an RLD return value, and the t# refers to a Huffman table ID used for the LRD.

The VLD2, which is a VLD function for MPEG-2, can be used in a form of “VLD2 [t#] in >v1, v2, v3;” Here, the t# refers to the Huffman table ID, the in refers to an inputted index value and the v1, v2 and v3 refer to output result value.

Finally, the VLD4, which is a VLD function for MPEG-4, can be used in a form of “VLD4 [T#]>CSCI;” Here, the t# refers to the Huffman table ID, and the “>CSCI” refers to the CSCI index to be stored. If the “>CSCI” is not designated as an option, it is set to store it in an only variable IBS.

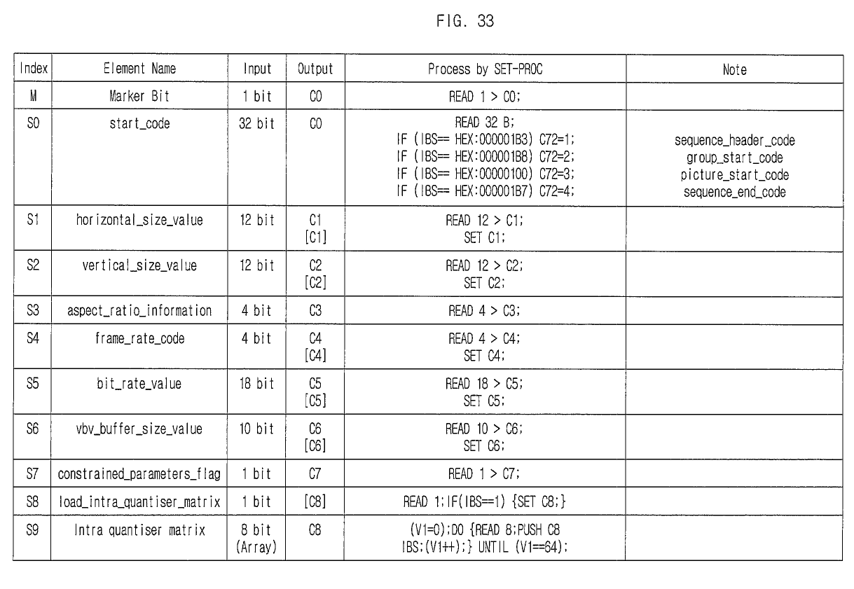

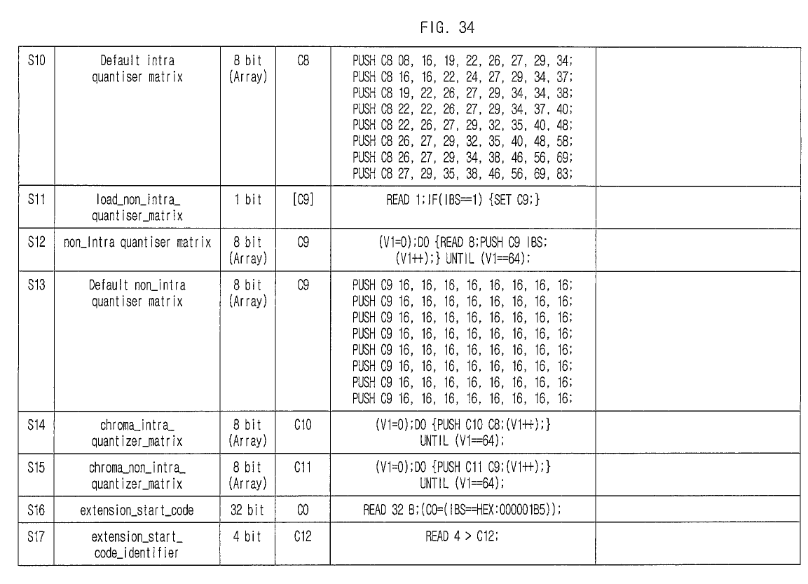

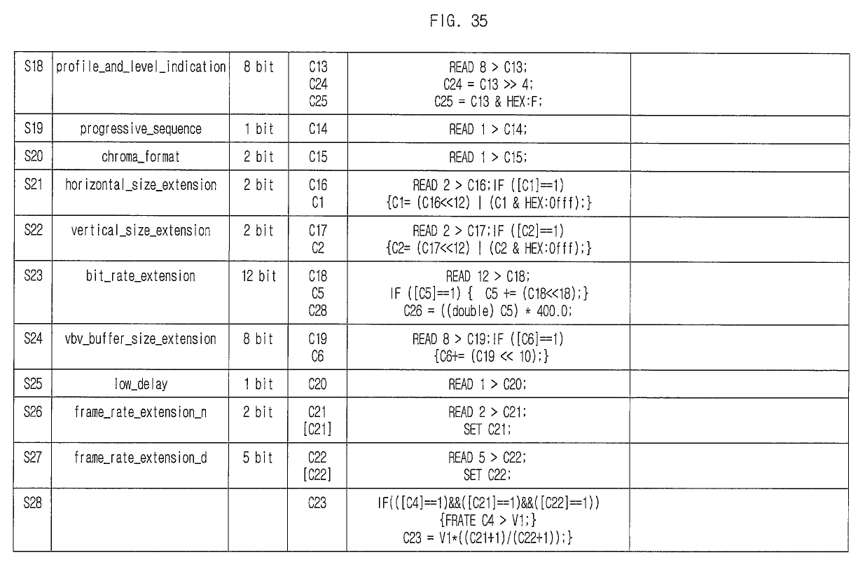

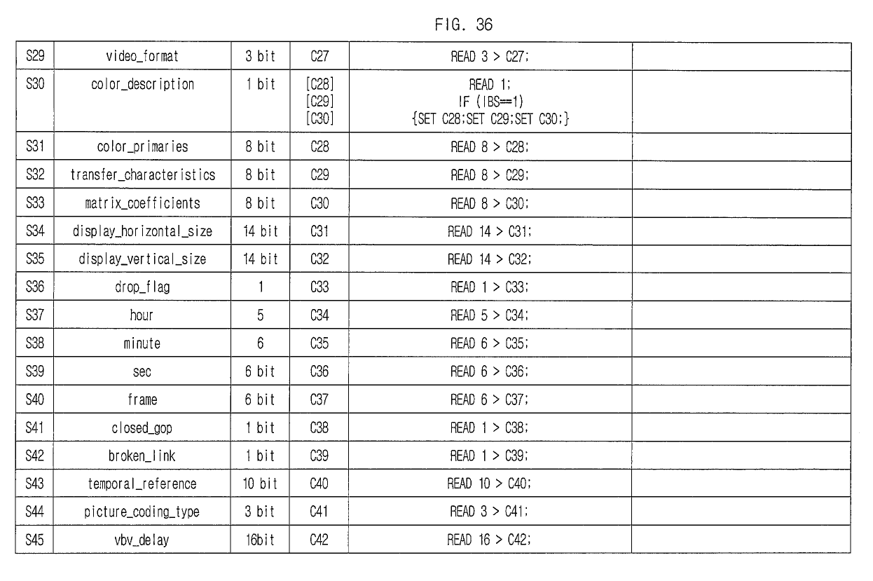

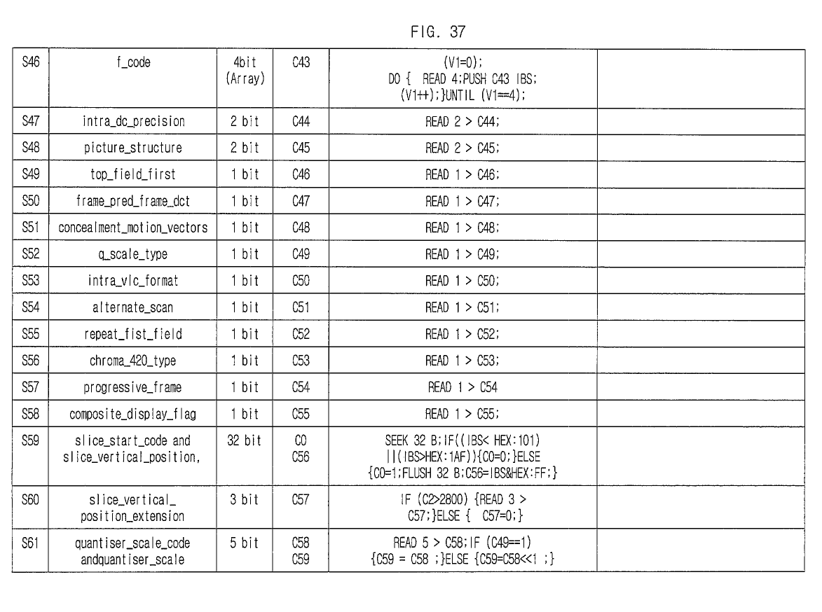

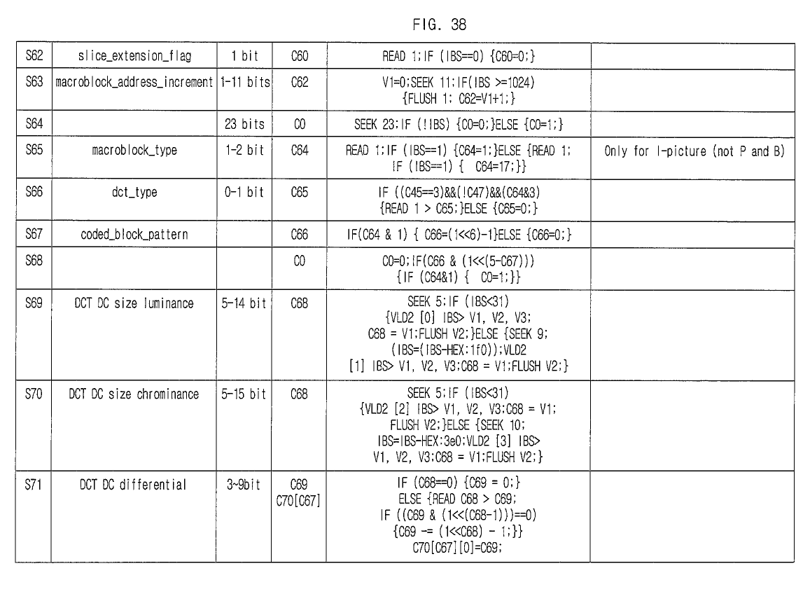

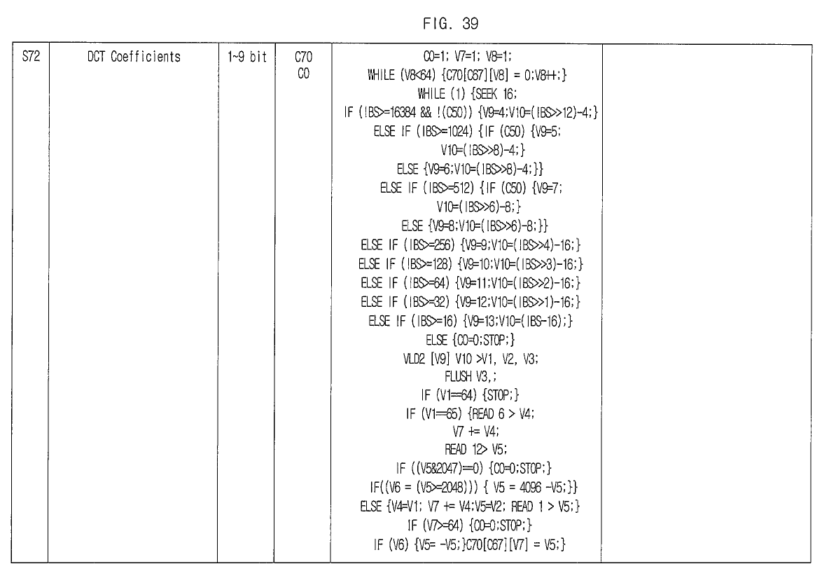

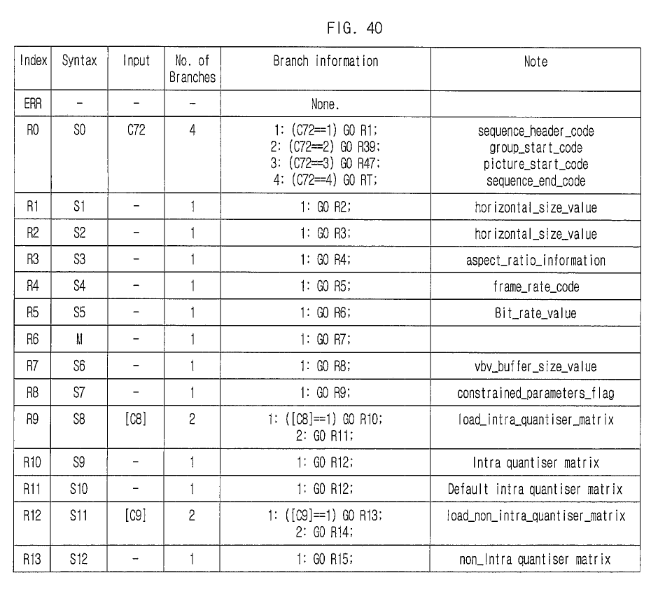

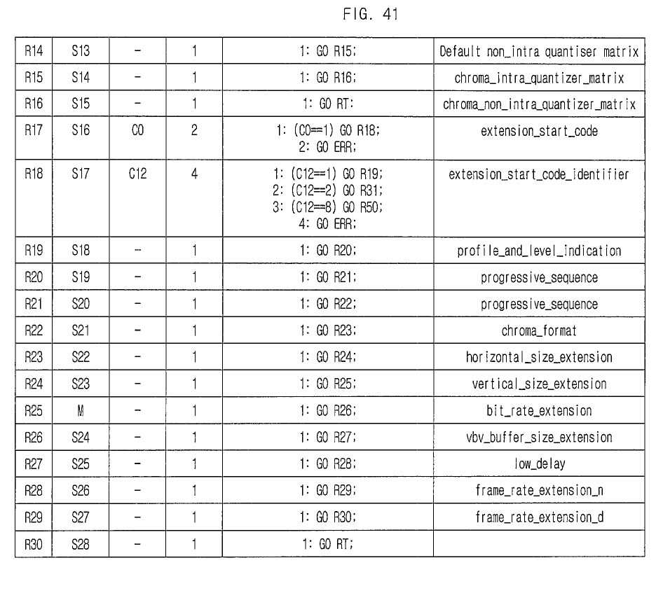

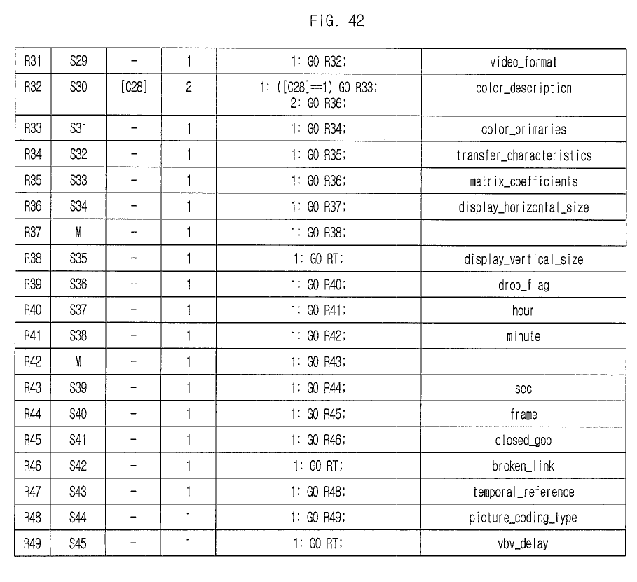

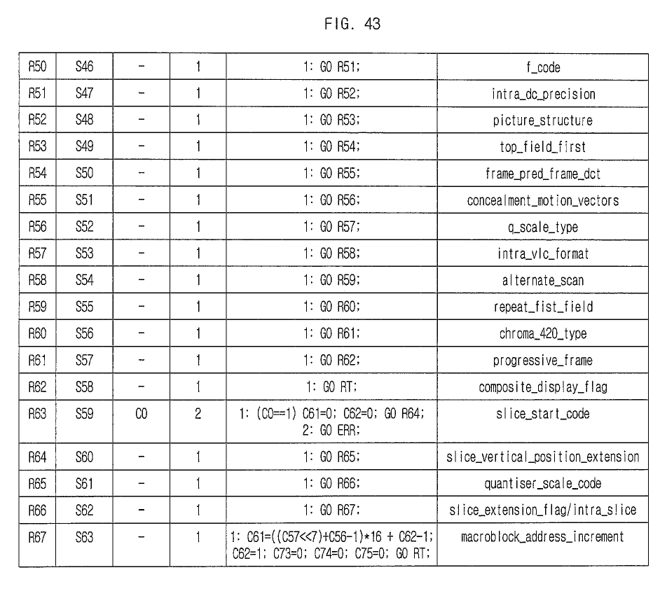

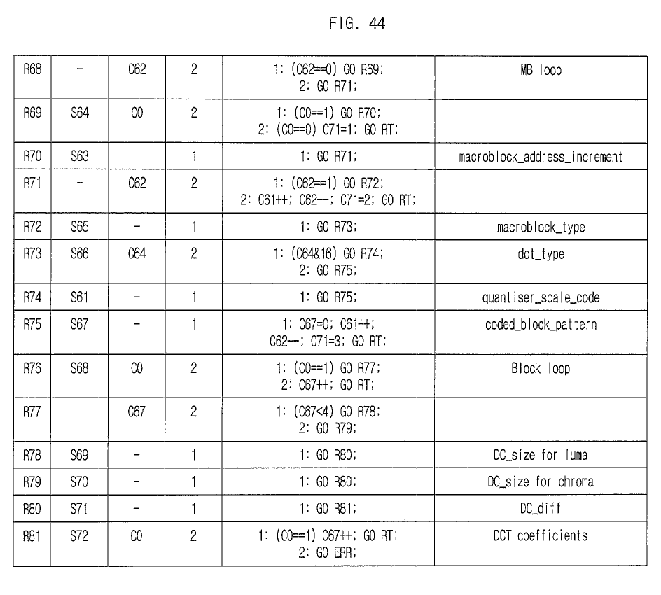

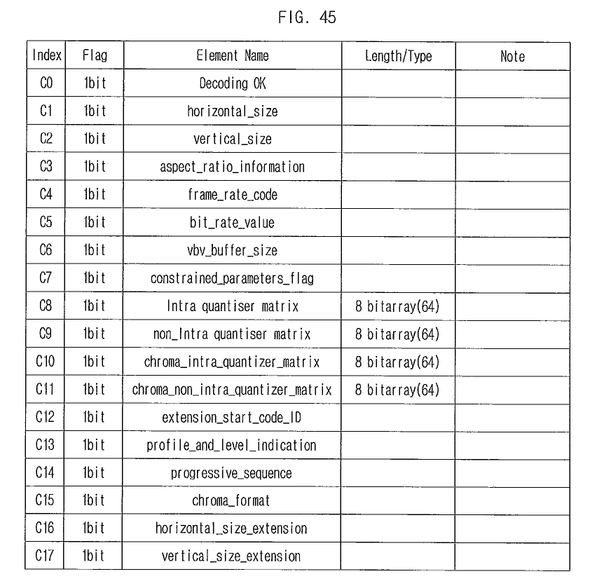

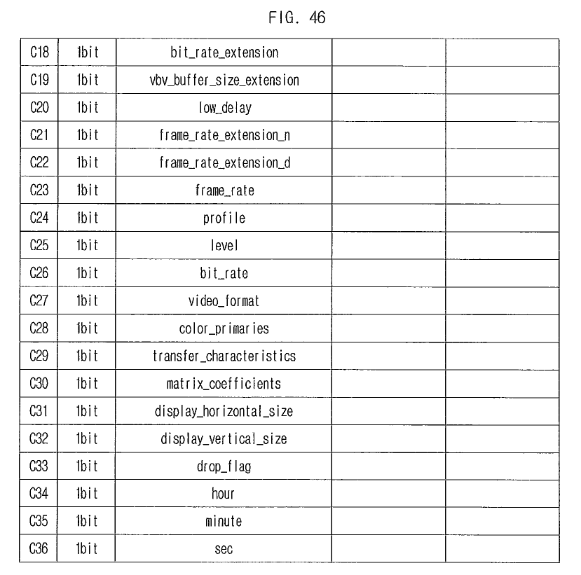

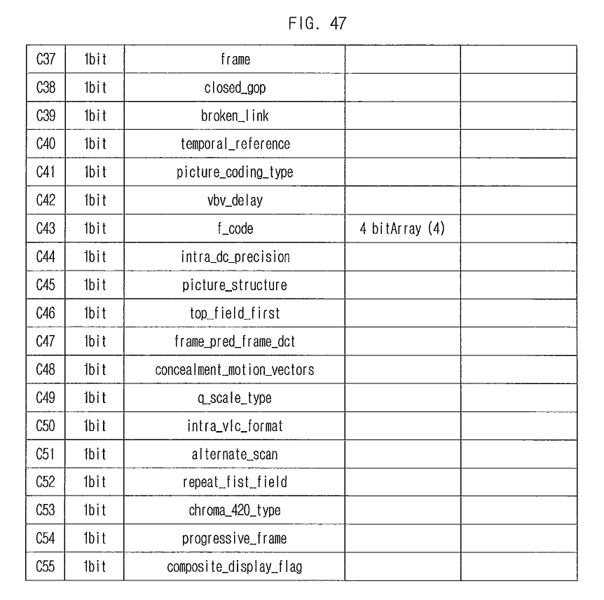

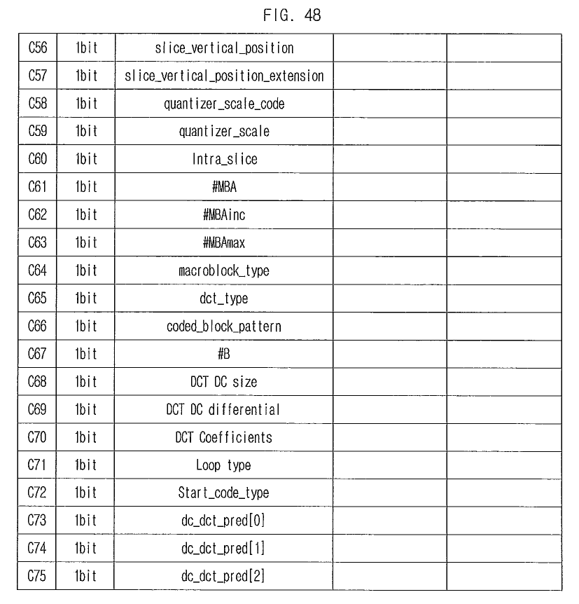

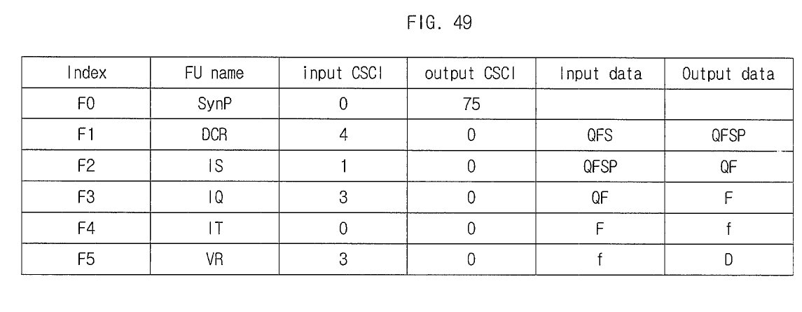

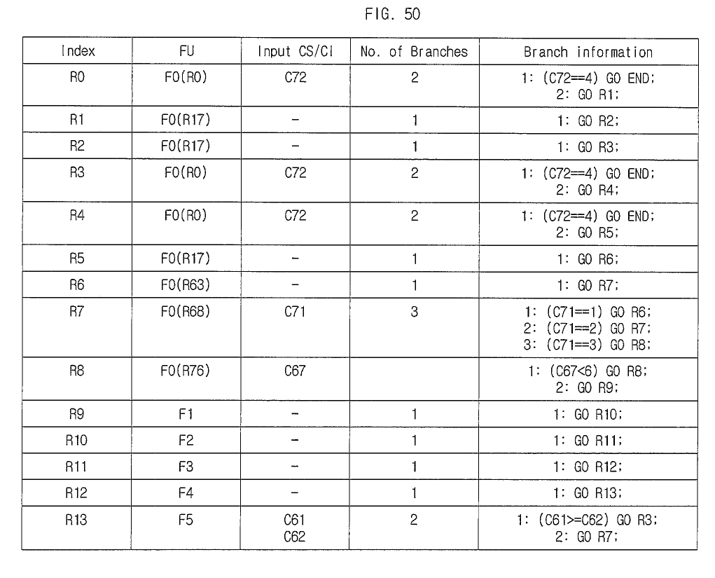

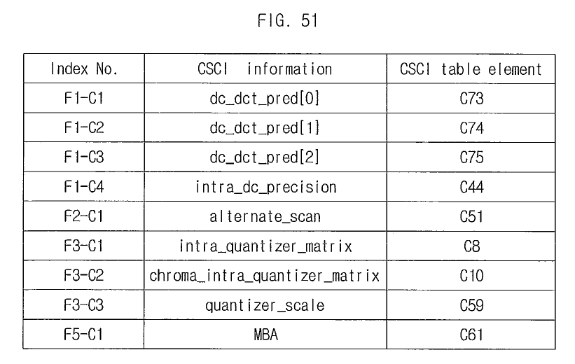

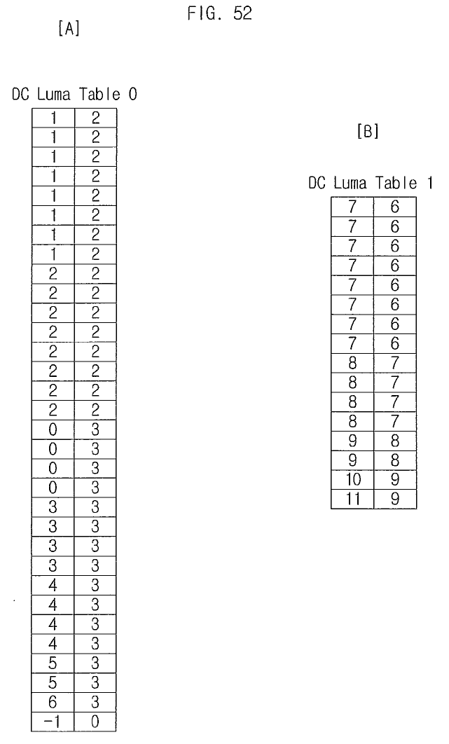

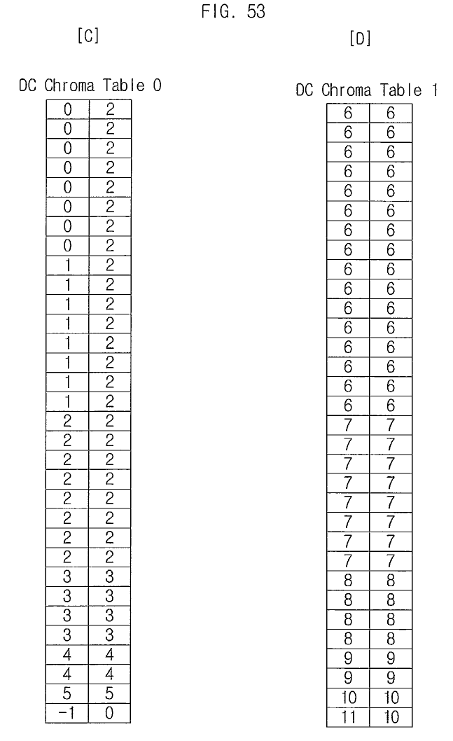

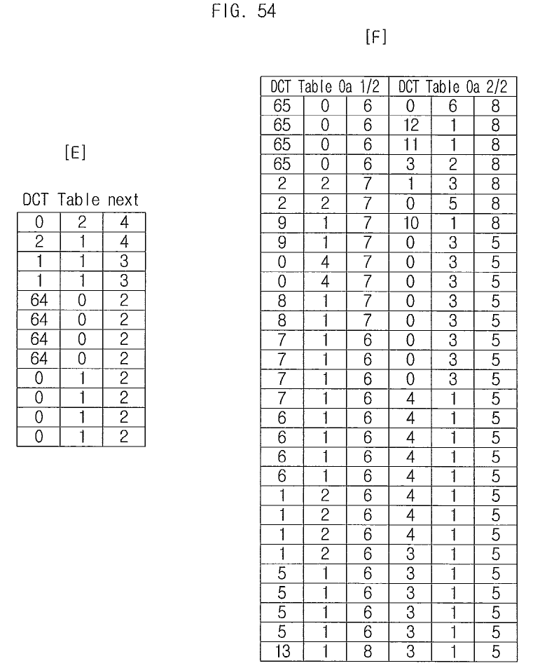

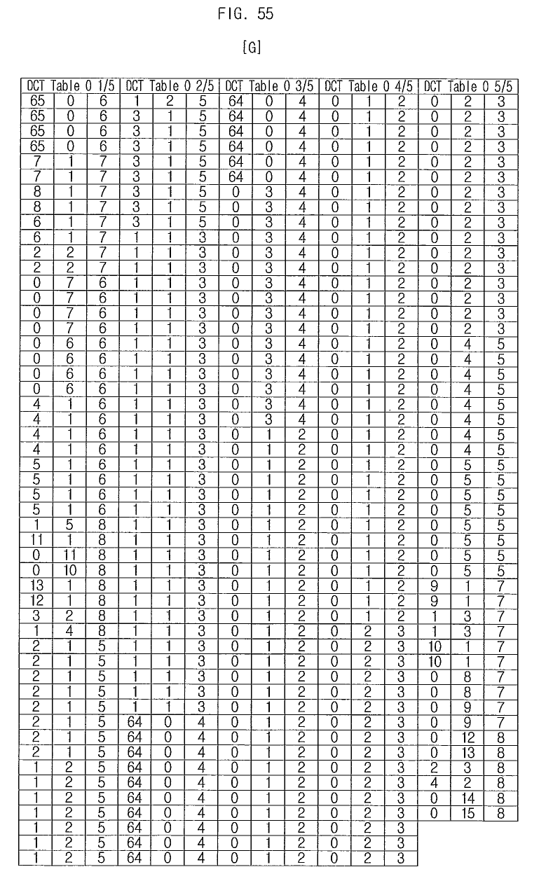

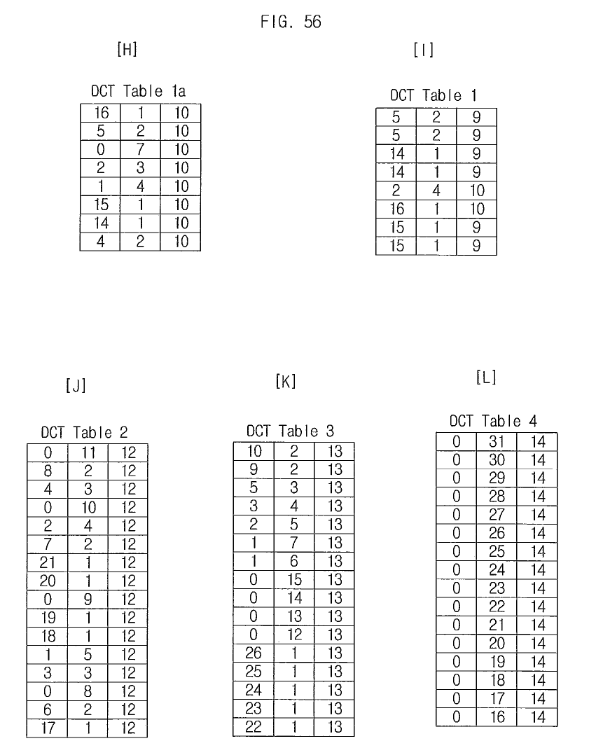

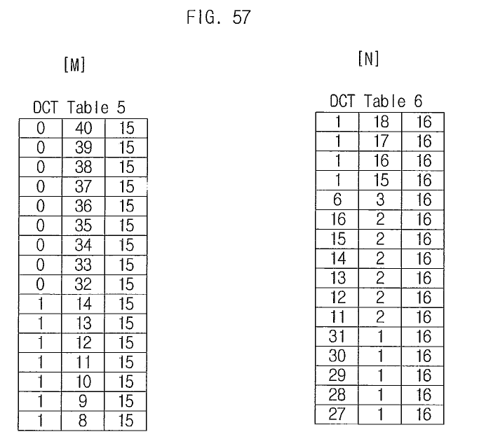

The detailed examples of each table formed by the aforementioned commands (i.e. each partial decoder description for the syntax processing for MPEG-2 MP intra coding) are illustrated through FIG. 33 and FIG. 57. In detail, the SET 450 is illustrated in FIG. 33 through FIG. 39, the S-RT 460 is illustrated FIG. 40 through FIG. 44, the CSCIT 440 is illustrated in FIG. 45 through FIG. 48, the FL 410 is illustrated in FIG. 49, the F-RT 420 is illustrated in FIG. 50, the FU-CSCIT 430 is illustrated in FIG. 51 and the DVT 470 is illustrated in FIG. 52 through FIG. 57.

Since the linking between each partial decoder description has been already described in detail, the generalization of the linking will be briefly described below.

The linking between the partial decoder descriptions for the syntax parsing is firstly performed in index order of the F-RT 420 (refer to FIG. 49). In other words, the linking is started from the index of R0.

The R-RT 420 recognizes the index number (F#) of the functional unit corresponding to the index number (R#) to be currently processed. For example, if the index number to be currently processed is R0, F0 (i.e. the parsing functional unit of the FL 410) is recognized. If the index number to be currently processed is R9, F1 (i.e. the DCR of FL 410 is recognized.

First, the case that the pertinent functional unit is the syntax (i.e. the index number F0 of the FL 410) by the recognized index number will be described.

R# is recognized by using “F#(R#) information written in a “FU” field of the F-RT 420, and the index of S# corresponding to the index of R# in the S-RT 460 is recognized. For example, the “FU” field of the index R0 of the F-RT 420 is written with “F0(R0),” and R0 corresponds to S0 of a syntax field of the S-RT 460.

Then, “Process by SET-PROC” corresponding to the recognized S# is recognized in the SET 450. For example, “Process by SET-PROC” of the SET corresponding to the S0 of the syntax field of the S-RT 460 is “READ 32 B; IF (IBS==HEX:000001B3) C72=1; IF (IBS==HEX:000001B8) C72=2; IF (IBS==HEX:00000100) C72=3; IF (IBS==HEX:000001B7) C72=4;”

The result of calculating the “Process by SET-PROC” of the SET 450 is stored corresponding to C# of an “output” field of the pertinent index S#. For example, the “Process by SET-PROC” of the SET corresponding to the S0 of the syntax field of the S-RT 460 is stored as C72.

If the calculating result is completed to be stored, it is determined by re-referring to the S-RT 460 which branch information the stored CSCI information satisfies. In the case of the index R0 of the S-RT 460, it is determined which one of the branch information “1: (C72==1) GO R1; 2: (C72==2) GO R39; 3: (C72=3) GO R47; and 4: (C72==4) GO RT;” C72 of the CSCI. In the case of satisfying any one of 1 through 3 in the aforementioned 4 conditions, the corresponding index R# in the S-RT 460 progresses and the aforementioned operation is repeated. However, in the case of satisfying the forth condition (i.e. (C72==4) GO RT), the operation returns to the F-RT 420.

Then, the case that that the pertinent functional unit is not the syntax (i.e. the index number F0 of the FL 410) by the recognized index number will be described.

The number of an input CSCI corresponding to the pertinent F# is recognized by using the FL 410 and the “F#” written in the “FU” field of the F-RT 420. For example, “F1” is written in the “FU” field of the index R9 of the F-RT 420. In the FL 410, F1 is the DCR and the request of 4 input CSCI is written.

If the number of input CSCI requested by referring to the FL 410 is not zero, the CSCI value C# corresponding to a “F#(C#)” field is recognized by referring to the FU-CSCIT 440, and the corresponding value is read in the CSCI storing unit 530.

Then, the pertinent functional unit generates output data by using inputted data (e.g. MB data) and input CSCI values, and then, returns to the F-RT 420.

As described above, in case that the pertinent functional unit is not the parsing functional unit (i.e. the index number F0 of the FL 410), if it satisfies “GO RT,” a predetermined operation is completed, and then, returns to the F-RT 420.

The F-RT 420 determines the branch condition according to the C# of the current step, and the corresponding step progresses. If the satisfied condition is END (e.g. (C72==4) GO END;), the syntax parsing is ended. If the satisfied condition is to direct to the R# (e.g. GO R1), the pertinent index is progressed.

FIG. 9 illustrates the structure of a extended bitstream in accordance with a first embodiment of the present invention, FIG. 10 illustrates the structure of a extended bitstream in accordance with a second embodiment of the present invention, FIG. 11 illustrates the structure of a extended bitstream in accordance with a third embodiment of the present invention and FIG. 12 illustrates the structure of a extended bitstream in accordance with a forth embodiment of the present invention.

As illustrated in FIG. 9 through FIG. 11, the decoder description included in the extended bitstream 305 of the present invention can be configured so as not to include partial decoder description information but to include applied standard information (no table), so as to include all partial decoder description information (full tables) and so as to include only some partial decoder description information (partial tables). In order to identify each of them, the decoder description information can include stream identifier (SI) information. The SI information can include some items as shown in the follow table 2.

TABLE 2
Stream Identifier

| SI | Decoder description |
|---|---|
| 00 | No table |
| 01 | Full tables |
| 10 | Partial tables |

As illustrated in FIG. 9, the extended bitstream 305, which is decoder description that is encoded decoder description 313 and is to be decoded to be partial decoder descriptions, can include an SI 910 (i.e. 00) indicating ‘no table’ and a codec number 920 and a profile and level number 930.

This shows the case of not sending the partial decoder description information but using the partial decoder description information already stored in the description storing unit 510. Although the pertinent conventional bitstream 316 sends basic information related to the used codec and profile and level, the decoding processing unit 320 can perform the decoding by using the designated partial decoder description e.

For this, the SET (450), the CSCIT (440), the FL (410), the FU-CSCIT (430) and the DVT (470) can be described per applied standard (i.e. codec), and the F-RT 420 and the S-RT 460 can be described per profile of each applied standard.

TABLE 3
Table Identifier per codec

| Standard | Partial decoder description identifier | | | | |
|---|---|---|---|---|---|
| MPEG-1 | SET #1 | FL #1 | FU-CSCIT #1 | CSCIT #1 | DVT #1 |
| MPEG-2 | SET #2 | FL #2 | FU-CSCIT #2 | CSCIT #2 | DVT #2 |
| MPEG-4 | SET #3 | FL #3 | FU-CSCIT #3 | CSCIT #3 | DVT #3 |
| AVC | SET #4 | FL #4 | FU-CSCIT #4 | CSCIT #4 | DVT #4 |

TABLE 4
Table Identifier per profile and level

| | |
|---|---|
| | Partial decoder |
| SI | description identifier |

| | | |
|---|---|---|
| MPEG-1 | F-RT #1-1 | S-RT #1-1 |
| MPEG-2 MP | F-RT #2-1 | S-RT #2-1 |
| MPEG-4 SP | F-RT #3-1 | S-RT #3-1 |
| MPEG-4 ASP | F-RT #3-2 | S-RT #3-2 |
| AVC BP | F-RT #4-1 | S-RT #4-1 |

In the case of MPEG-4 SP, the decoding method can be described by using SET#3, FL#3, CSCIT#3, FU-CSCIT#3, DVT#3, F-RT#3-1, and S-RT#3-1. If the codec number is designated as 3 and the profile and level number is designated as 2, the decoding processing unit 320 can perform the decoding operation by referring to the corresponding Partial decoder description.

Also, as illustrated in FIG. 10, the extended bitstream 305, which is a decoder description, can include all aforementioned partial decoder description information. In this case, when referring to the table 2, the SI 910 will be set as 01. Each partial decoder description can include a table identifier (IT) 1010, a table start code (TS code) 1020, a table description (TD) 1030 and a table end code (TE code) 1040. The order of the IT 1010 and the TS code can be changed, and the TD 1030 cam be described in a form of binary description. Of course, the order of each partial decoder description can be changed.

Also, as illustrated in FIG. 10, the extended bitstream 305, which is the decoder description, can include some aforementioned partial decoder description information and a codec number corresponding table information. In this case, when referring to the table 2, the SI 910 will be set as 10. However, in this case, since the format of the partial decoder description information is not unified, preferably, a format identifier 1110 can be further equipped behind the TI 1010 so as to determine the format of the pertinent partial decoder description information.

Beside that, as illustrated in FIG. 12, the extended bitstream 305 can further include a decoder description related to the table information (T-DD) 1210 and renewing information. The T-DD 1210 can be any one of decoder descriptions described by referring to FIG. 9 through FIG. 11, and the S1910 will be set as the corresponding value. The renewing information can include a revision start code (RS code) 1220 and a revision 1230.

The revision 1230, which is added, deleted or renewed with regulation rule of an arbitrary partial decoder description, can be provided in a form of ‘insert index into table-name ( )’, ‘delete index from table-name;’, ‘update index in table-name( )’

For example, in the case of adding S100 into the SET#4, the revision 1230 can be provided in a form of ‘insert 5100 into SET#4 (“READ 1;IF (IBS==1){SET C31;}”);’ In the case of deleting R31 from the S-RT#3-1, the revision 1230 can be provided in a form of ‘delete R31 from S-RT#3-1;’ In the case of updating R7 in the F-RT#2-1, the revision 1230 can be provided in a form of ‘update R7 in F-RT#2-1 (F6, 1: (C66<=6) GO R5; 2: (C65<=C67) GO R4; 3: GO R12;);’

While the description decoder 505 reads the revision 1230 and the decoding of the pertinent extended bitstream 305 is performed, the partial decoder descriptions changed with their revisions are allowed to be stored. However, once the decoding is completed, the pertinent partial decoder descriptions stored in the description storing unit must be returned to an original state. The decoding processing unit 320 or the trigger can notify a completing notification, related to whether to complete the decoding, to the description decoder 505 or the description decoder 505 can monitor whether the completion of the decoding processsing unit 320 is performed.

As described above, in accordance with the present invention, the conventional profile can be by using a functional unit provided by the conventional standard (i.e. codec), a new decoder can be configured by using the conventional functional unit or a new decoder can be realized by using a new functional unit. In other words, a decoder can be embodied without any restriction.

Only in the case of adding a new functional unit into the toolbox 515, the algorithm (i.e. a description related to the functional unit) related to the pertinent functional unit must be added and the pertinent information must be added into the FL 410. In this case, there can be additionally requested a compile operation related to the algorithm.

To realize a unified codec, each element must be organically controlled such that a bitstream, encoded by various encoding methods, can be decoded by a decoding method corresponding to the pertinent encoding method, by parsing the encoded bitstream.

In this case, the pertinent bitstream can be the bitstream formed in various forms mixed with diverse standards (codecs) or generated by various encoding methods in one standard. Also, various functional units used in the diverse standards must be divided into separate units, and an only function necessary for a user must be selected to make one codec (encoder or decoder), in order to support various decoding/encoding methods.

As described above, the present invention can organically connect and control each functional unit by an identical information analyzing method regardless of an encoding method encoded with a bitstream by allowing a decoder description to be provided.

Also, although the syntax of a bitstream is changed or newly added, the appropriate processing can be performed by only changing the pertinent information of the S-RT 460 or only inserting the additional information. Beside that, the connection of functional units of the Tool box 515 in the pertinent decoder can be set by selecting a function necessary for user and forming the F-RT 420 in processing units of bitstream level, frame level and MB level.

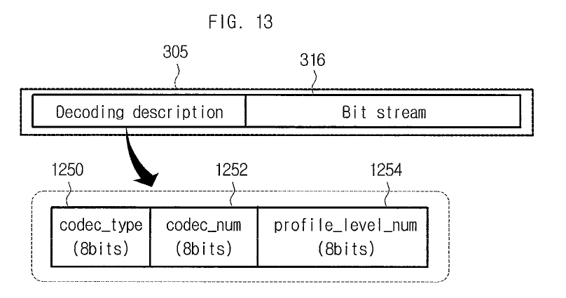

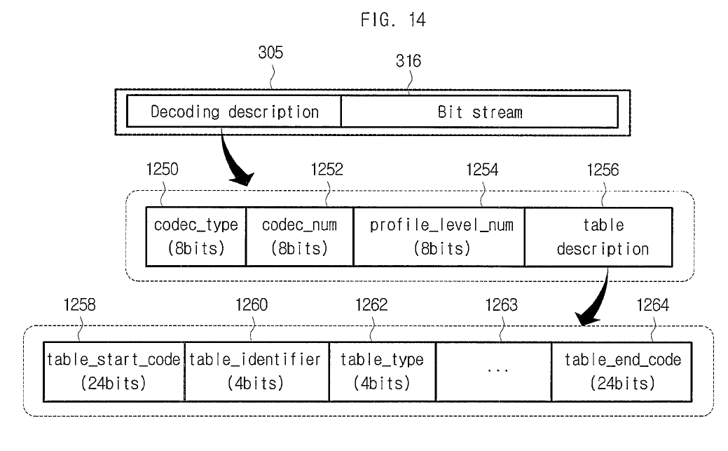

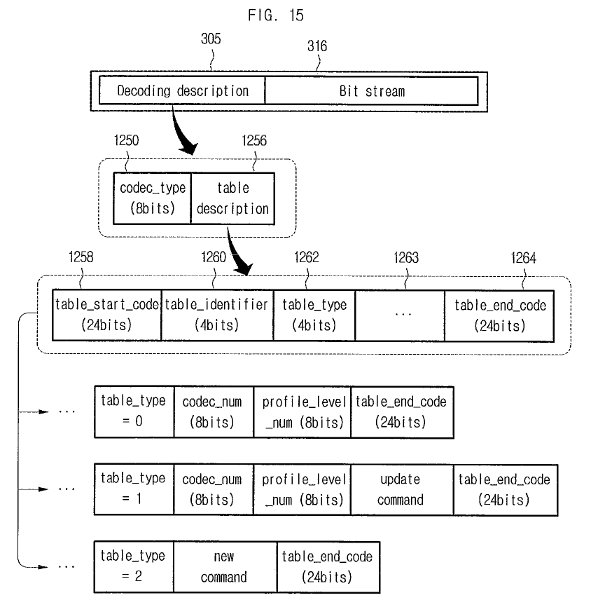

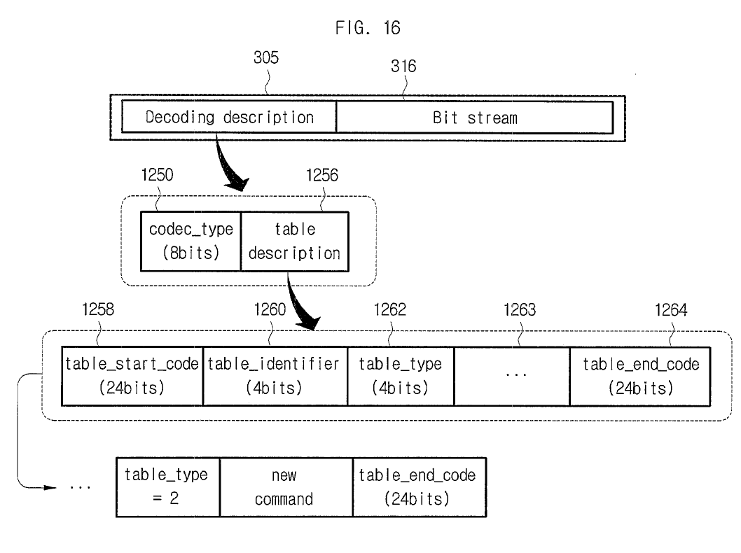

FIG. 13 illustrates the structure of a extended bitstream in accordance with a fifth embodiment of the present invention, FIG. 14 illustrates the structure of a extended bitstream in accordance with a sixth embodiment of the present invention, FIG. 15 illustrates the structure of a extended bitstream in accordance with a seventh embodiment of the present invention and FIG. 16 illustrates the structure of a extended bitstream in accordance with an eighth embodiment of the present invention.

The extended bitstream 305 of the present invention consists of a decoder description (DD) part and the conventional bitstream 316, it is well-known to those of ordinary skill in the art that the conventional bitstream 316 consists of coded video data (or/and coded audio data).

Here, the DD part having a different structure can be formed in accordance with the codec property to be applied for decoding the conventional bitstream 316. In other words, first, in the case of using one standardized codec, a first decoder description structure can be applied.

Second, in the case of changing some contents of one codec and using the codec (i.e. using the partial decoder description contents, as they are, corresponding to the pertinent codec in some partial decoder descriptions of the 7 aforementioned partial decoder descriptions and changing and using the other partial decoder descriptions), a second decoder description structure can be applied.

Third, in the case of processing and using the partial decoder description information of the conventional standardized plural codec, (i.e. selectively using the partial decoder description contents of the conventional standardized plural codec for some partial decoder descriptions of the 7 aforementioned partial decoder descriptions and changing and using the other partial decoder descriptions), a third decoder description structure can be applied.

Fourth, in the case of using a new codec that is not conventionally standardized (including and transmitting all 7 aforementioned partial decoder descriptions formed with new contents), a fourth decoder description structure can be applied.

The 4 aforementioned structures of the decoder descriptions can be identified as different codec type information, respectively. For example, the first decoder description structure is set as “codec_type=0”. The second decoder description structure is set as “codec_type=1”. The third decoder description structure is set as “codec_type=2”. The fourth decoder description structure is set as “codec_type=3”.

FIG. 13 illustrates the first decoder description structure.

In accordance with the first decoder description structure is illustrated in FIG. 12. The decoder description part can consist of a codec type 1250, a codec number 1252 and a profile and level number 1254. In other words, in accordance with the first decoder description structure, the decoder description part is described based on only information related to the codec to be applied. Although the drawings assume that each field is 8 bits, it shall be obvious that the size of each field can be adjusted depending on the magnitude of information to be represented.

The codec type 1250 will be set as zero (i.e. codec_type=0). This shows the case of using one codec, as it is, of the conventional various standardized codecs.

FIG. 14 illustrates the second decoder description structure.

In accordance with the second decoder description structure illustrated in FIG. 13, the decoder description part can consist of the codec type 1250, the codec number 1252, the profile and level number 1254 and the table description 1256. In other words, in accordance with the second decoder description structure, the decoder description part is described based on the information related to the codec to be applied and changed contents of 7 partial decoder descriptions. Here, the table descriptions are individually equipped in the 7 partial decoder descriptions, respectively. In other words, there can be 7 table descriptions in the decoder description part.

Each table description 1256, as illustrated in FIG. 13, can include the table start code 1258, the table identifier 1260, the table type 1262, the content 1263 and the table end code 1264. Of course, the size of each field can be increased or decreased as necessary. Also, as described below, the content 1263 can be omitted or included according to the information of the table type 1262.

For example, if the value of the table type 1262 is zero, the table description 1256 can be recognized so as to be applied without changing an existing partial decoder description (i.e. table recognized by the codec type 1250, the codec number 1252, the profile and level number 1254 and the table identifier 1260). In this case, the content 1263 can be omitted.

However, if the value of the table type 1262 is 1, the table description 1256 can be recognized so as to partially change (i.e. change to the contents defined in the contents 1263) and use an existing partial decoder description (i.e. table recognized by the codec type 1250, the codec number 1252, the profile and level number 1254 and the table identifier 1260). In this case, the content 1263 can be described with the changed content (e.g. a update command). For example, the changed content (e.g. the update command) can be the information including commands such as update, insert, or/and delete and changing the partial decoder description content of the index corresponding to the pertinent partial decoder description.

However, if the value of the table type 1262 is 2, the table description 1256 can be recognized so as to completely change (i.e. change to the contents defined in the contents 1263) and use an existing partial decoder description (i.e. table recognized by the codec type 1250, the codec number 1252, the profile and level number 1254 and the table identifier 1260). In this case, the content 1263 can be described with the changed content (e.g. content for newly defining the pertinent partial decoder description such as a new command).

FIG. 15 illustrates the third decoder description structure.

In accordance with the third decoder description structure illustrated in FIG. 15, the decoder description part can consist of the codec type 1250 and the table description 1256. In other words, in accordance with the third decoder description structure, the decoder description part is described based on the information related to the codec to be applied and the changed contents of the 7 tables. Here, the table descriptions are individually equipped in the 7 partial decoder descriptions, respectively. In other words, there can be 7 table descriptions in the decoder description part.

Each table description 1256, as illustrated in FIG. 14, can include the table start code 1258, the table identifier 1260, the table type 1262, the content 1263 and the table end code 1264. Of course, the size of each field can be increased or decreased as necessary.

For example, if the value of the table type 1262 is zero, the table description 1256 can be recognized so as to be applied without changing an existing partial decoder description (i.e. table recognized by the codec number 1252, the profile and level number 1254 and the table identifier 1260). In this case, there are described the codec number 1252 corresponding to the partial decoder description to be applied to a field of the content 1263, and the profile and level number 1254.

However, if the value of the table type 1262 is 1, the table description 1256 can be recognized so as to partially change (i.e. change to the contents defined in changed contents 1266) and use an existing partial decoder description (i.e. table recognized by the codec number 1252, the profile and level number 1254 and the table identifier 1260). In this case, the content 1263 can be described with the changed content (e.g. update command), and a field of the changed contents 1266 can be described with the changed contents (e.g. the update command).

However, if the value of the table type 1262 is 2, the table description 1256 can be recognized so as to completely change (i.e. change to the contents defined in the field of the content 1263) and use an existing partial decoder description (i.e. partial decoder description recognized by the codec type 1250, the codec number 1252, the profile and level number 1254 and the table identifier 1260). In this case, the content 1263 can be described with the changed content (e.g. content for newly defining the pertinent table such as a new command). In other words, as described above, if the table type 1262 is zero or 1, a specific codec is used as it is or some tables are changed and used. Accordingly, the information related to the codec (i.e. the codec number 1252 and the profile and level number) is requested. If the table type 1262 is 2, completely new partial decoder description information is defined. Accordingly, the additional codec information is not requested.

FIG. 16 illustrates the fourth decoder description structure.

In accordance with the fourth decoder description structure illustrated in FIG. 16, the decoder description part can consist of the codec type 1250 and the table description 1256. In other words, in accordance with the fourth decoder description structure, the decoder description part is described based on the 7 partial decoder descriptions. The table descriptions are individually equipped in the 7 partial decoder descriptions, respectively.

Each table description 1256, as illustrated in FIG. 14, can include the table start code 1258, the table identifier 1260, the table type 1262, the content 1263 and the table end code 1264. Of course, the size of each field can be increased or decreased as necessary.

For example, if the value of the table type 1262 is a predetermined value (e.g. 2), the field of the content 1263 is displayed with the information for describing a new partial decoder description corresponding to the table identifier 1260 (e.g. content for newly defining the pertinent table such as the new command). As described above, in case that the codec type 1250 is 3, it is recognized that the decoding is performed by using new tables. Accordingly, one table type 1262 can be designated or the table type 1262 can be omitted.

Hereinafter, the syntax structure of the decoder description part and the syntax structure of each field are illustrated in each below table.

TABLE 5
Decoder description

| Decoder_Description( ) { | No. of bits |
|---|---|
| codec_type | 8 |
| if ((codec_type==0x00) \|\| (codec_type==0x01)) { | |
| Codec_Description( ) | |
| } | |
| if (codec_type!=0x00) { | |
| do { | |
| Table_Description( ) | |
| } while (next_bits( )==table_idetifier) | |
| } | |
| } | |

TABLE 6
Codec Description

| Codec_Description( ) { | No. of bits |
|---|---|
| codec_num | 8 |
| profile_level_num | 8 |
| } | |

TABLE 7
Table Description

| Table_Description( ) { | No. of bits |
|---|---|
| table_start_code | 24 |
| table_identifier | 4 |
| table_type | 4 |
| if ((table_type ==‘0000’) \|\|(table_type ==‘0001’)) { | |
| if (codec_type==0x02) | |
| Codec_Description( ) | |
| if (table_type ==‘0001’) | |
| Update_Description( ) | |
| } | |
| if (table_type ==‘0010’) { | |
| New_Description( ) | |
| } | |
| table_end_code | 24 |
| } | |

TABLE 8
Update Description

| Update_Description( ) { | No. of bits | Mnemonic |
|---|---|---|
| Update_Command | | vlclbf |
| } | | |

TABLE 9
New Description

| New_Description( ) { | No. of bits | Mnemonic |
|---|---|---|
| New_Command | | vlclbf |
| } | | |

Hereinafter, the semantics of the decoder description are described with each below table.

TABLE 10
Decoder description

| Codec_type | Meaning |
|---|---|
| 0x00 | A profile@level of an existing MPEG standard |
| 0x01 | Some parts of the existing one profile@level changed |
| 0x02 | Some parts of the existing multiple profile@level changed |
| 0x03 | A new decoding solution |

Here, the codec type, which is a 8 bit code, can be the information for identifying the codec type.

TABLE 11
Codec Description

| Codec_num | MPEG standards and others |
|---|---|
| 01 | MPEG-1 |
| 02 | MPEG-2 |
| 03 | MPEG-4 Part 2 |
| 04 | MPEG-4 Part 10 (AVC) |
| 05-FF | RESERVED |

Here, the codec type, which is a 8 bit code, can be the information for indicating the code of a used codec code. Also, the profile and level number, which is a bit code, can be the information for directing to the number of the profile and level for the codec. The profile and level number can be identical to that of the standard of each MPEG standard.

TABLE 12
Table Description (Table identifier)

| Table_identifier | Table name |
|---|---|
| 0000 | SET (Syntax Element Table) |
| 0001 | S-RT (Syntax Rule Table) |
| 0010 | CSCIT (CSCI Table) |
| 0011 | DVT (Default Value Table) |
| 0100 | FL (FU List) |
| 0101 | F-RT (FU Rule Table) |
| 0110 | FU-CSCIT (FU CSCI Table) |
| 0111-1111 | RESERVED |

Here, the table start code can be 0xFFFFFE of hexadecimal 26-bit text strings, which refers to the start of the table description. The table identifier can be a 4 bit code as illustrated in the table 12 above.

TABLE 13
Table Description (Table type)

| Table_type | Meaning |
|---|---|
| 0000 | conventional table |
| 0001 | updated table |
| 0010 | new table |
| 0011-1111 | RESERVED |

Here, the codec type, which is a 4 bit code, can be the information for determining whether to maintain an existing table, to update the existing partial decoder description or to generate a new partial decoder description. The table end code can be 0xFFFFFE of hexadecimal 26-bit text strings, which refers to the end of the table description.

TABLE 14
Directing set for update_command

| Code | nstruction | Usage |
|---|---|---|
| 00 | UPDATE | UPDATE [index#] in [table#] [a record]; |
| 01 | INSERT | INSERT into [table#] [a record]; |
| 10 | DELETE | DELETE [index#] from [table#]; |
| 11 | RESERVED | |

Here, index# can be 4-bit strings directing to the index number of an arbitrary partial decoder description, and table# can be 32-bit strings as the table identifier.

TABLE 15
Directing set for new_command

| Code | Instruction | Usage |
|---|---|---|
| 00000001 | READ | READ bits B > CSCI; |
| 00000010 | SEEK | SEEK bits B > CSCI; |
| 00000011 | FLUSH | FLUSH bits B; |
| 00000100 | IF | If (condition) { ~ } |
| | | ELSE { ~ } |
| 00000101 | WHILE | WHILE (condition) { ~ } |
| 00000110 | UNTIL | UNTIL (condition) { ~ } |
| 00000111~0 | DO~WHILE | DO { ~ } WHILE (condition) |
| 00000111~1 | DO~UNTIL | DO { ~ } UNTIL (condition) |
| 00001000 | (~) (compute) | (...) |
| 00001001 | BREAK | BREAK; |
| 00001010 | SET | SET CSCI, CSCI; |
| 00001011 | STOP | STOP; |
| 00001100 | PUSH | PUSH CSCI Value, Value; |
| 00001101 | RLD | RLD index, level, run, islastrun, t#; |

Here, “bits” is any one of 3 through 34 bits for indicating the number of the requested bits, and “B” is 1-bit strings indicating a byte alignment. “>” is 1-bit strings for printing left output, and VLD2 (for MPEG-2) and VLD4 (for MPEG-4) is functions for entropy coding.

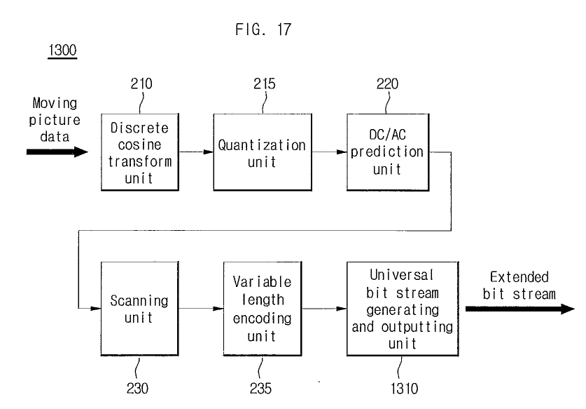

FIG. 17 is a block diagram illustrating an encoder in an embodiment of the present invention.

The encoder 1300 of the present invention further includes a universal bitstream generating and outputting unit 1310 as compared with the conventional encoder 200 described earlier by referring to FIG. 2. The universal bitstream generating and outputting 1310 generates a decoder description by using control information (e.g. the list and the connection of the used functional units, the input data of the pertinent functional units, the syntax information and the syntax connection information) in the generating operation of the conventional bitstream 105 generated by the processing of the prior operation. Beside that, the universal bitstream 305 is generated by using the generated decoder description and the conventional bitstream 105 to be transmitted to the decoder 300. Since the method of generating the decoder description is understood enough by those of ordinary skill in the art with only aforementioned descriptions, the pertinent description will be omitted.

The variable length encoding unit 235 of the present invention is merely pointed to an element for finally performing the encoding to the conventional bitstream 105 in the encoder 1300, but not limited to the present invention. Also, this does not cause to restrict the scope of claims of the present invention.

FIG. 17 assumes the case of providing the universal bitstream 305, generated by using decoder description information and the conventional bitstream 305, to the decoder.

However, as described above, the decoder description can be transferred in a form of separate data or bitstream to the decoder 300. In this case, it shall be obvious that the decoder description generating and outputting is not located behind the variable length encoding unit 235, but is provided independently of the conventional encoding unit, so as to provide independently generated information to the decoder 300.

Although the above description related to a unified codec device and method of the present invention is based on a decoder, the mutual relation between the decoder and an encoder is well-known to those of ordinary skill in the art, and considering that the encoder can be easily formed through the only detailed description related to the decoder, it is obvious that the present invention is not limited to the decoder.

As described above, the unified codec device and method of the present invention makes it easy to analyze a syntax element and control the connection of functional units in one standard (or codec) or between standards (or codecs). In other words, it is no problem to change the order of syntax elements in the bitstream generated according to a specific standard, to add a new syntax element or to delete the existing syntax element.

Beside that, in accordance with the conventional art, the decoder was unable to properly decode the pertinent bitstream in the manipulation of the syntax element. For example, if the bitstream of ABC is changed to ACB and transmitted, the decoder is unable to recognize the bitstream of ACB, to thereby making it impossible to properly decode the bitstream of ACB. Similarly, in the case of adding F and forming ABFC or deleting B and forming AC, the proper decoding is impossible.

However, in accordance with the unified codec device and method of the present invention, since the decoder description information is provided in a form of being included in the universal bitstream or separate data, the decoding operation of the decoder 300 can be smoothly performed.

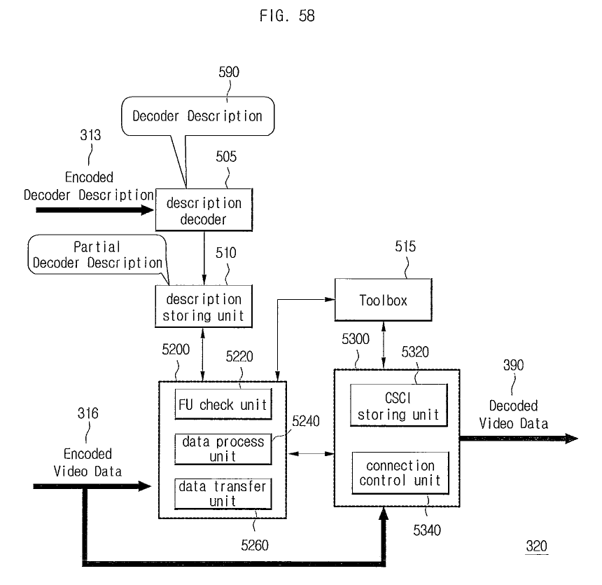

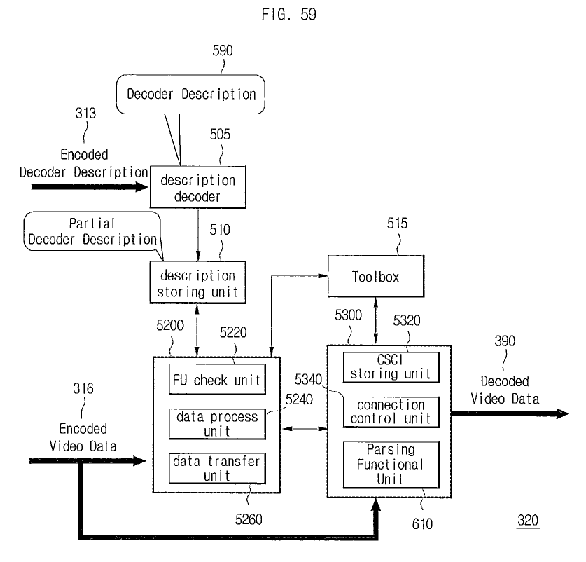

FIG. 58 is a schematic block diagram illustrating the structure of a decoding processing unit in accordance with the third embodiment of the present invention and FIG. 59 is a schematic block diagram illustrating the structure of a decoding processing unit in accordance with the forth embodiment of the present invention.

As illustrated in FIG. 58, the third embodiment of the decoding processsing unit 320 can include a description decoder 505, a description storing unit 510, a toolbox 515, and decoder implementation unit 520.

The decoder implementation unit 5200 can include a FU check unit 5220, a data process unit 5240, a data transfer unit 5260.

The FU check unit 5220 checks if the every functional unit is described in partial decoder descriptions (such as FL 410) exists in the toolbox 515 after the partial decoder descriptions are stored in description storing unit 510 by process of description decoder 505.

If there are not any functional units among functional units described in the partial decoder descriptions in toolbox 515, error massage can be displayed in a display unit or update of corresponding functional units can be request to a user. Of course, the FU check unit 5220 can automatically update through the network if it is connected to a server for update of functional units.

The data process unit 5240 classifies the partial decoder descriptions stored in the description storing unit 510 by the role of the partial decoder descriptions and process the partial decoder descriptions such that the partial decoder descriptions has the data format that can be operated by decoding solution 5300. This is because the format (such as table format) of the partial decoder description stored in description storing unit 510 is not suitable or the decoding solution 5300 may need some information for efficiency.

As the function and format of the each partial decoder description is described above, only the processed data format is briefly described below.

The data process unit 5240 process CSCI control information and connection control information after classifying the each partial decoder description according to the role for being used for generating or storing CSCI (Control Signal/Context Information) or the role for being for connecting the functional units.

For example, the partial decoder descriptions used for generating CSCI can be SET 450, S-RT 460, CSCIT 440 and DVT 470 and the partial decoder descriptions used for generating the connection control information can be FL 410, F-RT 420, S-RT 460 and FU-CSCIT 440.

The CSCI control information and connection control information processed by the data processing unit 5240 can be described by the representation format of abstract decoder model ADM as follows.

Of course, it is obvious that the representation format is not restricted by the only ADM format.

First, the CSCI control information can be described as follows.

```
<CSCIs>
  <csci_memory id=“C0” name=“CSCI #0” type=“integer” />
  <csci_memory id=“C1” name=“CSCI #1” type=“integer” />
  <csci_memory id=“C2” name=“CSCI #2” type=“array” />
  <csci_memory id=“C3” name=“CSCI #3” type=“integer” />
  <csci_memory id=“C4” name=“CSCI #4” type=“integer” />
  <csci_memory id=“C5” name=“CSCI #5” type=“integer” />
  <csci_memory id=“C6” name=“CSCI #6” type=“integer” />
  <csci_memory id=“C7” name=“CSCI #7” type=“integer” />
  <csci_memory id=“C8” name=“CSCI #8” type=“integer” />
  <csci_memory id=“C9” name=“CSCI #9” type=“integer” />
  <csci_memory id=“C10” name=“CSCI #10” type=“integer” />
  <csci_memory id=“C11” name=“CSCI #11” type=“integer” />
  <csci_memory id=“C12” name=“CSCI #12” type=“integer” />
  ......
</CSCI>
```

Next, the connection control information can be described as follows.

```
  <Network name=“Decoder”>
  <Package>
  <QID>
  <ID id=“MPEG4 Simple Profile” />
  </QID>
  </Package>
  <Port kind=“Input” name=“BITSTREAM” />
  <Port kind=“Ouput” name=“YUV” />
  <Instance id=“1”>
  <Class name=“Parser”>
  <QID>
  <ID id=“c” />
  </QID>
  </Class>
  <Note kind=“label” name=“Stream Parser” />
  </Instance>
  <Instance id=“2”>
  <Class name=“VS”>
  <QID>
  <ID id=“c” />
  </QID>
  <Note kind=“label” name=“Video Session” />
  </Class>
  </Instance>
  <Connection src=“” src-port=“BITSTREAM” dst=“1”
dst-port=“BITSTREAM” />
  <Connection src=“1” src-port=“CSCI” dst=“2” dst-port=“CSCI” />
  <Connection src=“1” src-port=“DATA” dst=“2” dst-port=“DATA” />
  <Connection src=“2” src-port=“YUV” dst=“” dst-port=“YUV” />
  </Network>
```

The data transfer unit 5260 transfer the CSCI control information and connection control information processed by the data process unit 5240 to the decoding solution 5300. The data transfer unit 5260 can transfer CSCI control information to CSCI storing unit 5320 of which role is the storing and operating the CSCI information and can transfer connection control information to a connection control unit 5340. In the case that the CSCI storing unit 5320 store only CSCI information and the operation of CSCI information is performed by connection control unit 5340, it is obvious that the data transfer unit 5240 can CSCI control information and connection control information can be transferred.

The decoding solution 5300 includes CSCI storing unit 5320 and connection control unit 5340. Although it is not illustrated, the decoder solution 5300 can additionally include a work memory for loading the functional units by connection control unit 5340 and performing the predetermined process using them.

The forth embodiment of the decoding processing unit 320 is illustrated in FIG. 59. The forth embodiment of the decoding processing unit 320 can include a description decoder 505, a description storing unit 510, a toolbox 515, a decoder implementation unit 5200, and a decoding solution 5300.

As compared to the FIG. 58, the forth embodiment of the decoding processing unit 320 in FIG. 59 can additionally include a parsing functional unit 610.

The parsing functional unit 610 is the functional unit for performing syntax parsing of bitstream.

The parsing functional unit 610 can be included the decoding solution 5300 as an independent element. However, instead of the structure that the parsing functional unit 610 is included the decoding solution 5300, it is also obvious that the decoding solution 5300 includes two work memories and the connection control unit controls the one work memory to load only the functional units for decoding process and controls the other work memory to load only the parsing functional unit 610.

The both structures mentioned above have advantages that the parsing process of bitstream and decoding process can be parallel performed.

Besides that, compared to FIG. 58, the data process unit 5240 processes syntax parsing control information and provides the syntax parsing control information to the decoding solution 5300 for the process of the parsing functional unit 610. Accordingly, the role of the partial decoder descriptions used for generating the CSCI control information, the connection control information and the syntax parsing control information.

That is, the data process unit 5240 classifies the partial decoder descriptions by the role for generating and storing of CSCI, the role for syntax parsing, and the role for connecting the functional units and then processes the CSCI control information, the connection control information, and the syntax parsing control information.

For example, the partial decoder descriptions used for generating CSCI can be CSCIT 440 and the partial decoder descriptions used for generating the connection control information can be FL 410, F-RT 420, and FU-CSCIT 440 and the partial decoder descriptions used for generating the syntax parsing control information can be SET 450, S-RT 460, CSCIT 440 and DVT 470.

AS mentioned above, the CSCI control information and connection control information processed by the data processing unit 5240 can be described by the representation format of abstract decoder model ADM. Below is the example of the representation of syntax parsing control information.

```
<syntax>
  <syntax_element id=“S0” name=“Syntax #0”>
    <process>
      <cmd type=“READ”>
        <parameter index=0>32</parameter>
        <parameter index=1>B</parameter>
      </cmd>
      <cmd type=“EXPRESSION”>
        <parameter index=0>(C0=(IBS==HEX:1B0))</parameter>
      </cmd>
    </process>
  </syntax_element>
  <syntax_element id=“S1” name=“Syntax #1”>
    <process>
      <cmd type=“READ”>
        <parameter index=0>8</parameter>
        <output type=“CSCI”>C1</output>
      </cmd>
    </process>
  </syntax_element>
  (......)
</syntax>
```

The data transfer unit 5260 transfer the CSCI control information and connection control information and syntax parsing control information processed by the data process unit 5240 to the decoding solution 5300.

The data transfer unit 5260 can transfer CSCI control information to CSCI storing unit 5320 of which role is the storing and operating the CSCI information and can transfer connection control information to a connection control unit 5340 and can transfer syntax parsing control information to the parsing functional unit 610.

In the case that the CSCI storing unit 5320 store only CSCI information and the operation of CSCI information is performed by connection control unit 5340, it is obvious that the data transfer unit 5240 can CSCI control information and connection control information can be transferred.

Besides that, if the parsing functional unit 610 performs syntax parsing by the control of the connection control unit 5340, it is also obvious that the data transfer unit 5240 can transfer the syntax parsing control information to the connection control unit 5340.

The decoding solution 5300 includes a CSCI storing unit 5320, a connection control unit 5340, and a parsing functional unit 610. The decoder solution 5300 can additionally include a work memory for loading the functional units by connection control unit 5340 and performing the predetermined process using them.

The parsing functional unit can be the functional unit being able to perform syntax parsing of every bitstream regardless of their encoding format or the functional unit that are generated for syntax parsing of a certain type of bitstream. That is, the parsing functional unit 610 can be more than one functional unit for performing syntax parsing.

As illustrated in FIG. 58 and FIG. 59, the decoder 300 of the present invention can reconfigure the decoding process according to the encoding type of the inputted bitstream by selectively loading and operating the functional units in the toolbox 515.

As mentioned above, the decoder implementation unit 5200 or the connection control unit 5340 performs the function for implementing the decoder to decode the inputted bitstream and the decoding solution 5300, which is the decoder configured by control of the decoder implementation 5200 or the connection control unit 5340, performs the decoding process of the bitstream.

The present invention can implement plural decoding solutions using a decoder implementation information by dividing two parts which are relation of cause and effect in their functions and then provide more efficient decoding process.

It shall be obvious that although the above description related to a decoding device and method of the present invention is based on MPEG-4 AVC, MPEG-1, MPEG-2, MPEG-4 and other moving picture encoding/decoding standards can be applied without any restriction.

Beside that, it is obvious that the information included in each partial decoder description can be described by using not only the information the connection of functional units for performing the decoding by one standard and the information related to the processing operation requested for the pertinent functional unit but also the information for performing the decoding by a plurality of standards.

For example, it is assumed that an initial plurality of frames of encoded video data included in the universal bitstream are encoded by using MPEG-2, the following plurality of frames are encoded by using MPEG-4 and the other frames are encoded by using MPEG-1. In this case, it is obvious that partial decoder description information included in the decoder description for decoding the encoded video data will be realized such that the functional units according to each standard included in the toolbox 515 can be organically coupled and operated, in order that each frame having different encoding methods can be decoded.

The drawings and detailed description are only examples of the present invention, serve only for describing the present invention and by no means limit or restrict the spirit and scope of the present invention. Thus, any person of ordinary skill in the art shall understand that a large number of permutations and other equivalent embodiments are possible. The true scope of the present invention must be defined only by the spirit of the appended claims.

### INDUSTRIAL APPLICABILITY

The present invention is applicable to a video codec.

1. A decoding device, comprising:
a tool box including a plurality of functional units, each of the functional units realized to perform a predetermined process; and
a decoder implementation unit controlling to load selectively the functional units and to decode inputted bitstream into video data by using partial decoder descriptions.

2. The decoding device of claim 1, further comprising:
a description storing unit storing partial decoder descriptions for controlling all or some operations of the functional units; and
a description decoder generating one or more partial decoder descriptions using an encoded decoder description inputted to correspond to the bitstream and storing the partial decoder description in the description storing unit, or designating one or more of a plurality of partial decoder descriptions previously stored in the description storing unit.

3. The decoding device of claim 1, wherein the toolbox comprises:
at least one parsing functional unit for performing syntax parsing of the bitstream; and
a plurality of decoding functional units for a decoding process of the bitstream.

4. The decoding device of claim 3, wherein the decoder implementation unit comprises:
a storing unit, storing control signal/context information and information for decoding process generated by the process of at least one of the plurality of functional units; and
a connection control unit controlling the selective loading of the functional units.

5. The decoding device of claim 3, wherein the decoder implementation unit comprises:
a work memory for performing a process of the functional unit loaded by the control of the decoder implementation unit, or
the decoder implementation unit is connected to the work memory.

6. The decoding device of claim 2, further comprising a dividing unit dividing an extended bitstream into the encoded decoder description and the bitstream and outputting the encoded decoder description and the bitstream when the extended bitstream, which includes the encoded decoder description and the bitstream, is inputted.

7. The decoding device of claim 1, wherein the partial decoder descriptions comprise:
a syntax element table (SET) indicating a process for generating information related to a bit-stream syntax and element information corresponding to the bit-stream syntax;
a syntax rule table (S-RT), indicating the connection between the bit-stream syntaxes;
a control signal and context information table (CSCIT), indicating detailed information related to the element information,
an FU-rule table (F-RT), successively selecting the plurality of functional units;
an FU list (FL), indicating a list of the functional units; and
an FU-CSCIT, indicating element information to be inputted into the selected functional unit.

8. The decoding device of claim 7, further comprising a default value table (DVT) indicating the relation between an actual value and a code value when entropy coding.

9. The decoding device of claim 7, wherein the encoded decoder description is decoded into the decoder description, which is configured to include at least one partial decoder description part, and at least one information for generating or recognizing the partial decoder description corresponding to each partial decoder description is inserted into the decoder description part.

10. The decoding device of claim 9, wherein the information comprises a codec number for decoding the bit-stream, and designating information corresponding to a profile and level number, and the description decoder extracts n tables, corresponding to the designating information, from a plurality of partial decoder descriptions pre-stored in the description storing unit.

11. The decoding device of claim 9, wherein the table information inserted individually into at least one of the partial decoder description parts comprises binary code information for forming each respective partial decoder description, and the description decoder generates n partial decoder descriptions by using the binary code information and stores the generated n tables in the description storing unit.

12. The decoding device of claim 9, wherein m partial decoder description parts, m being a natural number, of the n partial decoder description parts comprise a codec number related to a corresponding partial decoder description and designating information corresponding to a profile and level number, and k partial decoder description parts, k being a number of n−m, comprises binary code information for forming a corresponding partial decoder description, and
the decoder description decoder extracts m partial decoder descriptions, corresponding to the designating information, from a plurality of pre-stored partial decoder descriptions and generates k partial decoder descriptions by using the binary code information and stores the k generated partial decoder descriptions in the description storing unit.

13. An encoding device, comprising:
an encoding unit, converting inputted video data into a bitstream according to a predetermined encoding method by successively using a plurality of functional units; and
a description information generating unit, generating syntax information of the bitstream and description information according to the connection of the functional units,
whereas the bitstream and the description information are provided to a decoding device.

14. A decoding method, comprising:
(a) generating and storing a plurality of partial decoder descriptions corresponding to inputted decoder description;
(b) loading selectively a functional unit among a plurality of functional units disposed in a tool box by using at least one partial decoder description; and
(c) performing a predetermined process for decoding an inputted bitstream, the predetermined process being performed by the functional unit selectively loaded in the step (b).

15. The decoding method of claim 14, wherein the steps of (b) and (c) are repeated until video data which is decoded from the bitstream is outputted.

16. The decoding method of claim 14, wherein the predetermined process for each of the functional units disposed in the tool box is realized to independently perform each function suggested by a plurality of standards for decoding the bit-stream.

17. The decoding method of claim 14, wherein a corresponding loaded functional unit stores its result data in a buffer memory that can be accessed by a following loaded functional unit.

18. The decoding method of claim 14, wherein a corresponding loaded functional unit provides its result data to a following loaded functional unit as input data.

19. The decoding method of claim 14, wherein the partial decoder description comprise:
a syntax element table (SET) indicating a process for generating information related to a bit-stream syntax and element information corresponding to the bit-stream syntax;
a syntax rule table (S-RT) indicating the connection between the bit-stream syntaxes;
a control signal and context information table (CSCIT) indicating detailed information related to the element information;
an FU-rule table (F-RT) successively selecting the plurality of functional units;
an FU list (FL) indicating a list of the functional units; and
an FU-CSCIT indicating element information to be inputted into the selected functional unit.

20. The decoding method of claim 19, wherein the partial decoder description further comprises a default value table (DVT) indicating the relation between an actual value and a code value when entropy coding.

21. The decoding method of claim 14, further comprising a step of dividing an extended bitstream into the encoded decoder description and the bitstream and outputting the encoded decoder description and the bitstream when the extended bitstream, which includes the encoded decoder description and the bitstream, is inputted.

22. A decoding device, comprising:
a decoder implementation unit generating and outputting Control Signal/Context Information (CSCI) control information and connection control information using partial decoder descriptions stored in a description storing unit;
a tool box including a plurality of functional units, each of the functional units realized to perform a predetermined process; and
a decoding solution loading selectively the functional units and decoding a bitstream into video data by using the CSCI and the connection control information.

23. The decoding device of claim 21, wherein the decoder implementation unit comprises:
an FU check unit checking whether the functional units described in the partial decoder description exists in the toolbox; and
a data process unit generating the CSCI control information and the connection control information by using the partial decoder descriptions.

24. The decoding device of claim 22, wherein the decoding solution comprises:
a CSCI storing unit storing a plurality of elements information generated by syntax parsing the bitstream by processing of at least one functional unit; and
a connection control unit controlling the operation of each functional unit by selectively loading a plurality of functional units by referring to the CSCI control information and the connection control information.

25. The decoding device of claim 22, wherein the decoding solution comprises:
a CSCI storing unit storing a plurality of elements information generated by syntax parsing the bitstream by the processing of at least one functional unit;
at least one parsing functional unit performing the syntax parsing of the bitstream according to the CSCI control information; and
a connection control unit controlling the operation of each functional unit by selectively loading a plurality of functional units by referring to the CSCI control information and the connection control information,
whereas the toolbox includes a plurality of decoding functional units for decoding the bitstream.

26. The decoding device of claim 22, wherein the partial decoder descriptions comprise:
a syntax element table (SET) indicating a process for generating information related to a bit-stream syntax and element information corresponding to the bit-stream syntax;
a syntax rule table (S-RT), indicating the connection between the bit-stream syntaxes;
a control signal and context information table (CSCIT), indicating detailed information related to the element information;
an FU-rule table (F-RT), successively selecting the plurality of functional units;
an FU list (FL), indicating a list of the functional units; and
an FU-CSCIT, indicating element information to be inputted into the selected functional unit.

27. The decoding device of claim 26, further comprising a default value table (DVT) indicating the relation between an actual value and a code value when entropy coding.

28. The decoding device of claim 24, wherein the functional unit loaded by the connection control unit performs the predetermined process by inputting either or both of predetermined element data and output data of the previously loaded functional unit.

29. The decoding device of claim 22, wherein the toolbox comprises:
at least one parsing functional unit performing syntax parsing of the bitstream; and
a plurality of decoding functional units for a decoding process of the bitstream.

30. The decoding device of claim 29, wherein the parsing functional unit generates element information using the CSCI control information.

31. The decoding device of claim 27, wherein the CSCI control information is generated by using the SET, CSCIT, S-RT, and DVT, and the connection control information is generated by using the FL, F-RT, FU-CSCIT and CSCIT.

32. A decoding method, comprising:
(a) generating and storing a plurality of partial decoder descriptions corresponding to an inputted decoder description;
(b) generating CSCI control information and connection control information using the partial decoder descriptions;
(c) storing a plurality of element information generated by syntax parsing the bitstream using the CSCI control information;
(d) decoding encoded video data of the bitstream using the connection control information and the element information and outputting the decoded video data.

33. The decoding method of claim 32, wherein the steps (c) and (d) are performed respectively by functional units selectively loaded among the functional units in a toolbox by a connection control unit referring to the connection control information.

34. The decoding method of claim 32, wherein the step (d) is performed repeatedly until the result of a process performed by functional units operated by a connection control unit loading becomes the video data.

35. The decoding method of claim 32, wherein the partial decoder descriptions comprise:
a syntax element table (SET) indicating a process for generating information related to a bit-stream syntax and element information corresponding to the bit-stream syntax;
a syntax rule table (S-RT), indicating the connection between the bit-stream syntaxes;
a control signal and context information table (CSCIT), indicating detailed information related to the element information;
an FU list (FL), indicating a list of functional units;
an FU-rule table (F-RT), successively selecting the plurality of functional units; and
an FU-CSCIT, indicating element information to be inputted into the selected functional unit.

36. The decoding device of claim 35, further comprising a default value table (DVT) indicating the relation between an actual value and a code value when entropy coding.

37. The decoding device of claim 36, wherein the CSCI control information is generated by using the SET, CSCIT, S-RT and DVT, and the connection control information is generated by using the FL, F-RT, FU-CSCIT and CSCIT.

38. A decoding device comprising:
a decoder implementation unit generating and outputting CSCI control information and connection control information using partial decoder descriptions stored in a description storing unit; and
a decoding solution decoding a bitstream into video data by selectively loading functional units using the CSCI control information and connection control information.
